(19) United States
(12) Patent Application Publication
(10) Pub. No.: US 2026/0358531 A1
(43) Pub. Date: Nov. 12, 2026

(54) ARTICLES WITH ANTI-GLARE SURFACES WITH SLOPED TRANSITION SURFACES AND ASSOCIATED METHODS

(71) Applicant: CORNING INCORPORATED, CORNING, NY (US)

(72) Inventors: Corinne Elizabeth Isaac, Horseheads, NY (US); Joon-Soo Kim, Yongin-si (KR); Min-woo Lee, West Henrietta, NY (US); Junghyun Noh, Hwaseong-si (KR); Wageesha Senaratne, Horseheads, NY (US); Binwei Zhang, Horseheads, NY (US)

(21) Appl. No.: 19/121,695

(22) PCT Filed: Oct. 27, 2023
(86) PCT No.: PCT/US2023/036079

§ 371 Date: Apr. 16, 2025

Related U.S. Application Data
(60) Provisional application No. 63/420,222, filed on Oct. 28, 2022.
(60) Provisional application No. 63/542,398, filed on Oct. 4, 2023.

(51) Int. Cl. G02B 1/11; G02B 5/02

(52) U.S. Cl. CPC G02B 1/11; G02B 5/0221

(57) ABSTRACT

Articles with scattering regions designed to exhibit anti-glare performance attributes are described herein. The scattering regions include a plurality of structures extending outward from a base plane of the first major surface. Each of the plurality of structures comprises a sloped portion extending from the base plane and a peak portion that is disposed at a peak height of that structure. The sloped portions of the plurality structures make up more than 5% of a total surface area of the scattering region. An Abbott-Firestone curve characterizing a 1×1 mm² portion of the scattering region comprises an intermediate portion between portions representing the base plane and the peak portions, with the intermediate portion having an average slope that is less than 420%/μm and greater than 5%/μm in magnitude.

### CROSS-REFERENCE TO RELATED APPLICATIONS

This application claims the benefit of priority under 35 U.S.C. § 119 of U.S. Provisional Application Ser. No. 63/420,222 filed Oct. 28, 2022, and U.S. Provisional Application Ser. No. 63/542,398 filed on Oct. 4, 2023, the contents of which are relied upon and incorporated herein by reference in their entirety.

### FIELD

The disclosure relates to articles with anti-glare surfaces with sloped transition surfaces and methods for fabricating the same.

### BACKGROUND

Substrates transparent to visible light are utilized to cover displays of display articles. Such display articles include smart phones, tablets, televisions, computer monitors, vehicle interior displays and the like. The displays are often liquid crystal displays and organic light emitting diodes, among others. The substrate protects the display, while the transparency of the substrate allows the user of the device to view the display. Glare is the phenomena associated with a degraded viewing experience in the presence of bright light sources. In addition, reflected images not from a bright light source but from the ambient can also contribute to a degraded viewing in displays. For example, a visually distinctive user's own reflected image, or light from the surrounding environment, can result in distraction, reduction in legibility, as well as visual fatigue.

Several techniques exist to reduce glare, including anti-reflective coatings and anti-glare technologies. An anti-reflection coating can reduce glare by directly reducing the total amount of reflection. However, certain existing anti-reflection coatings may fail to diminish reflections to a great enough extent throughout the visible spectrum to render such reflections unnoticed by users. Anti-glare technologies attempt to spread reflection of light to a large range of angles to reduce the peak intensity of the reflection and render distracting reflected images less distinct to the user. However, reflection at angles that are too large can result in relatively high haze that can reduce the contrast of the displayed images.

Accordingly, an alternative to existing anti-glare and anti-reflective coating technologies that allows favorable control of the angular distribution of scattered light would be beneficial.

### SUMMARY

An aspect (1) of the present disclosure pertains to an article comprising a substrate comprising: a first major surface; a second major surface opposing the first major surface; and a scattering region formed in the first major surface, wherein, within the scattering region, the first major surface comprises: a plurality of structures extending outward from a base plane of the first major surface, each of the plurality of structures extending to a peak height from the base plane, wherein: each of the plurality of structures comprises a sloped portion extending from the base plane and a peak portion that is disposed at the peak height of that structure, sloped portions of the plurality structures make up more than 5% of a total surface area of the scattering region, an Abbott-Firestone curve characterizing a 1×1 mm² portion of the scattering region comprises: (a) a first portion representing an area of the scattering region disposed most proximate to the base plane, (b) a second portion representing peak portions of the plurality of structures, and (c) an intermediate portion extending between the first portion and the second portion, and the intermediate portion comprises an average slope that is less than 420%/μm and greater than 5%/μm in magnitude.
An aspect (2) of the present disclosure pertains to an article according to the aspect (1), wherein the sloped portions make up more than 50% of the total surface area of the scattering region.
An aspect (3) of the present disclosure pertains to an article according to the aspect (1), wherein: at least some of the plurality of peak portions are etch depth portions disposed within 20 nm of a maximum peak height relative to the base plane, and the etch depth portions make up less than 60% of the total surface area of the scattering region.
An aspect (4) of the present disclosure pertains to an article according to the aspect (3), wherein the etch depth portions make up less than 40% of the total surface area of the scattering region.
An aspect (5) of the present disclosure pertains to an article according to any of the aspects (1)-(4), wherein the plurality structures comprise a maximum feature size that is greater than or equal to 1 μm and less than 200 μm.
An aspect (6) of the present disclosure pertains to an article according to any of the aspects (1)-(5), wherein at least some of the sloped portions extend a lateral distance that is greater than or equal to 1.0 μm and less than or equal to 10 μm between the base plane and the peak portion, wherein the lateral distance extended by a sloped portion is measured in a direction parallel to a surface normal of the sloped portion and parallel to the base plane.
An aspect (7) of the present disclosure pertains to an article according to the aspect (6), wherein the lateral distance is greater than or equal to 3.0 μm.
An aspect (8) of the present disclosure pertains to an article according to any of the aspects (6)-(7), wherein: each of the sloped portions comprises a first edge disposed proximate the base plane and a second edge disposed proximate to the peak region, and a slope of the first major surface changes along the direction over a 1 μm lateral distance at both the first edge and the second edge.
An aspect (9) of the present disclosure pertains to an article according to any of the aspects (1)-(8), wherein the first and second portions of the Abbott-Firestone curve are vertical portions having slopes greater than 350%/μm in magnitude.
An aspect (10) of the present disclosure pertains to an article according to the aspect (9), wherein: some of the peak portions are disposed within 20 nm of a maximum peak height relative to the base plane and those peak portions are represented in the second portion of the Abbott-Firestone curve, and the Abbott-Firestone curve comprises a third vertical portion representing peak portions that are disposed at peak heights between the base plane and the maximum peak height.
An aspect (11) of the present disclosure pertains to an article according to the aspect (10), wherein the Abbott-Firestone curve further comprises: a fourth vertical portion representing additional peak portions disposed at peak heights between the base plane and the maximum peak height other than the heights associated with the third vertical portion, wherein the intermediate portion is a first intermediate portion that is disposed between the first portion and the third vertical portion; a second intermediate portion disposed between the third vertical portion and the fourth vertical portion; and a third intermediate portion disposed between the fourth vertical portion and the second portion.
An aspect (12) of the present disclosure pertains to an article according to the aspect (11), wherein each of the first intermediate portion, the second intermediate portion, and the third intermediate portion is either: (a) a segment of the Abbott-Firestone curve representing at least 50 nm in heights having an average slope that is at least 50%/μm less than adjacent vertical portions; or (b) an inflection point of the Abbott-Firestone curve.
An aspect (13) of the present disclosure pertains to an article according to any of the aspects (1)-(12), wherein the article exhibits: a transmission haze of less than or equal to 3.5%, and a sparkle of less than or equal to 2.5% when measured at 140 ppi.
An aspect (14) of the present disclosure pertains to an article according to any of the aspects (1)-(13), wherein a bidirectional reflectance distribution function (“BRDF”) of the article that is measured from white light that is incident on the first major surface at an angle of incidence of 10° exhibits an intensity that is less than 1.2×10⁻⁴ sr⁻¹ at a scattering angle of 30° relative to specular.
An aspect (15) of the present disclosure pertains to an article according to any of the aspects (1)-(14), wherein a first average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.7 when the article is viewed at a 0° viewing angle and light having a luminance of 45000 lux is incident on the first major surface at an angle of incidence of 20°.
An aspect (16) of the present disclosure pertains to an article according to any of the aspects (1)-(15), wherein, after 100 cycles of a pad applying a 270 g force to CS8 material against the scattering region along a track, the scattering region exhibits a track visibility that is less than or equal to 40%.
An aspect (17) of the present disclosure pertains to an article comprising: a substrate comprising: a first major surface; a second major surface opposing the first major surface; and a scattering region formed in the first major surface, wherein, within the scattering region, the first major surface comprises: a plurality of structures extending outward from a base plane of the first major surface, each of the plurality of structures extending to a peak height from the base plane, wherein: (a) each of the plurality of structures comprises a sloped portion extending from the base plane and a peak portion that is disposed at the peak height of that structure, such that the scattering region comprises a plurality of sloped portions and a plurality of peak portions, (b) at least some of the sloped portions extend a lateral distance that is greater than or equal to 1.0 μm and less than or equal to 10 μm between the base plane and the peak portion, (c) the lateral distance extended by a sloped portion is measured in a direction parallel to a surface normal of the sloped portion and parallel to the base plane, (d) sloped portions of the plurality structures make up more than 5% of a total surface area of the scattering region, and (e) an Abbott-Firestone curve characterizing a 1×1 mm² portion of the scattering region does not include any horizontal portions representing at least 0.05 μm in heights having a slope less than 40%/μm in magnitude between heights representing the base plane and a peak height of the scattering region.
An aspect (18) of the present disclosure pertains to an article according to the aspect (17), wherein the sloped portions make up more than 5% of the total surface area of the scattering region.
An aspect (19) of the present disclosure pertains to an article according to any of the aspects (17)-(18), wherein: at least some of the plurality of peak portions are etch depth portions disposed within 20 nm of a maximum peak height relative to the base plane, and the etch depth portions make up less than 60% of the total surface area of the scattering region.
An aspect (20) of the present disclosure pertains to an article according to the aspect (19), wherein the etch depth portions make up less than 40% of the total surface area of the scattering region.
An aspect (21) of the present disclosure pertains to an article according to any of the aspects (17)-(20), wherein the plurality structures comprise a maximum feature size that is greater than or equal to 1 μm and less than 200 μm.
An aspect (22) of the present disclosure pertains to an article according to any of the aspects (17)-(21), wherein: the sloped portion of each structure comprises a first edge disposed proximate the base plane and a second edge disposed proximate to the peak region of that structure, wherein a slope of the first major surface changes along the direction over a 1 μm lateral distance at both the first edge and the second edge.
An aspect (23) of the present disclosure pertains to an article according to any of the aspects (17)-(22), wherein: the Abbot-Firestone curve comprises: a first portion representing an area of the scattering region disposed most proximate to the base plane, a second portion representing peak portions of the plurality of structures, and an intermediate portion extending between the first portion and the second portion, the intermediate portion comprises an average slope that is less than 420%/μm and greater than 5%/μm, the first and second portions of the Abbott-Firestone curve are vertical portions having slopes greater than 350%/μm in magnitude, and some of the peak portions are disposed within 20 nm of a maximum peak height and those peak portions are represented in the second portion of the Abbott-Firestone curve.
An aspect (24) of the present disclosure pertains to an article according to the aspect (23), wherein the Abbott-Firestone curve comprises a third vertical portion representing peak portions that are disposed at heights between the base plane and the maximum peak height.
An aspect (25) of the present disclosure pertains to an article according to the aspect (24), wherein the Abbott-Firestone curve further comprises: a fourth vertical portion representing additional peak portions disposed at peak heights between the base plane and the maximum peak height other than the heights associated with the third vertical portion, wherein the intermediate portion is a first intermediate portion that is disposed between the first portion and the third vertical portion; a second intermediate portion disposed between the third vertical portion and the fourth vertical portion; and a third intermediate portion disposed between the fourth vertical portion and the second portion.
An aspect (26) of the present disclosure pertains to an article according to the aspect (25) wherein each of the first intermediate portion, the second intermediate portion, and the third intermediate portion is either: (a) a segment of the Abbott-Firestone curve representing at least 50 nm in heights having an average slope that is at least 50%/μm less than adjacent vertical portions; or (b) an inflection point of the Abbott-Firestone curve.
An aspect (27) of the present disclosure pertains to an article according to any of the aspect (17)-(26), wherein the article exhibits: a transmission haze of less than or equal to 3.5%, and a sparkle of less than or equal to 2.5% when measured at 140 ppi.
An aspect (28) of the present disclosure pertains to an article according to any of the aspect (17)-(27), wherein a bidirectional reflectance distribution function (“BRDF”) of the article that is measured from white light that is incident on the first major surface at an angle of incidence of 10° exhibits an intensity that is less than 1.2×10⁻⁴ sr⁻¹ at a scattering angle of 30° relative to specular.
An aspect (29) of the present disclosure pertains to an article according to any of the aspect (17)-(28), wherein a first average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.7 when the article is viewed at a 0° viewing angle and light having a luminance of 45000 lux is incident on the first major surface at an angle of incidence of 20°
An aspect (30) of the present disclosure pertains to an article according to any of the aspect (17)-(29), wherein, after 100 cycles of a pad applying a 270 g force to CS8 material against scattering region along a track, the scattering region exhibits a track visibility that is less than or equal to 40%.
An aspect (31) of the present disclosure pertains to a method of forming a scattering region of a substrate for a display article, the method comprising: determining a pattern for a plurality of structures on a first major surface of the substrate, wherein each of the plurality of structures comprises a surface area disposed at a height measured relative to a base plane extending through the display article; disposing one or more etching masks on the first major surface that allow etching only on select regions of the first major surface for forming at least some of the plurality of structures; and after each etching mask of the one or more etching masks is disposed on the first major surface, contacting the display article with an etchant for a period of time so as form the plurality of structures in a primary etching step, removing the one or more etching masks from the first major surface, and exposing an entirety the scattering region to a secondary etchant so that the plurality of structures comprise sloped portions and corners of the plurality of structures are rounded.
An aspect (32) of the present disclosure pertains to a method of the aspect (31), wherein the exposing the entirety of the scattering region to the secondary etchant comprises dipping the article in a secondary etching solution comprising a concentration ratio of HF and HCl from 0.5M HF/0.5M HCl to 3M HF/3M HCl, such that an etching rate of the article is greater than 0.5 μm/min.
An aspect (33) of the present disclosure pertains to a method of the aspect (31), wherein the exposing the entirety of the scattering region to the secondary etchant comprises spraying the article with a secondary etching solution comprising a concentration ratio of HF and HCl from 16 mM HF/20 mM HCl to 160 mM HF/200 mM HCl to achieve an etching rate from 0.1 μm/min to 1 μm/min.
An aspect (34) of the present disclosure pertains to a method of any of the aspects (31)-(33), wherein the exposing the entirety of the scattering region to the secondary etchant is performed for a secondary etching period that is less than or equal to 20 minutes so that less than or equal to 20 μm of material is removed from the scattering region.
An aspect (35) of the present disclosure pertains to a method of any of the aspects (31)-(34), wherein after the primary etching step, the plurality of structures comprise a plurality of regions of the first major surface disposed at different heights relative to the base plane, wherein the heights differ from one another by 20 nm to 200 nm in a direction perpendicular to the base plane.
An aspect (36) of the present disclosure pertains to a method of any of the aspects (31)-(35), wherein the exposing the entirety of the scattering region to the secondary etchant reduces a fill fraction of the scattering region made up of unetched portions of the article in the primary etching step by at least 5%.

It is to be understood that both the foregoing general description and the following detailed description are merely exemplary, and are intended to provide an overview or framework to understanding the nature and character of the claims. The accompanying drawings are comprised to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present invention and, together with the description, explain the principles of the invention. In the drawings:

FIG. 1 depicts a perspective view of a display article, according to one or more embodiments of the present disclosure;

FIG. 2 schematically depicts a portion of a scattering region of the display article of FIG. 1, according to one or more embodiments of the present disclosure;

FIG. 3A schematically depicts a height profile of the scattering region depicted in FIG. 2, according to one or more embodiments of the present disclosure;

FIG. 3B schematically depicts a cross-sectional view of a transition surface between two regions at different heights of the scattering region depicted in FIG. 2, according to one or more embodiments of the present disclosure;

FIG. 4 is a flow diagram of a method of fabricating a display article including a scattering regions with structures having sloped transition regions, according to one or more embodiments of the present disclosure;

FIGS. 5A, 5B, and 5C are 2D cross-sectional height profiles of structures of articles formed without feature rounding, formed with feature rounding via mask undercutting, and formed with feature rounding via secondary etching, according to one or more embodiments of the present disclosure;

FIG. 6A is a surface height profile and surface height histogram associated with Example 5, according to one or more embodiments of the present disclosure;

FIG. 6B is a surface height profile and surface height histogram associated with Example 1, according to one or more embodiments of the present disclosure;

FIG. 7 is a plot showing Abbott-Firestone (“AF”) curves generated from 1×1 mm² portions of scattering regions of Examples 1-5, according to one or more embodiments of the present disclosure;

FIG. 8 schematically depicts an apparatus for measuring washout performance of an article, according to one or more embodiments of the present disclosure;

FIG. 9 schematically depicts a vehicle interior comprising displays and ambient light sources emitting light that is incident on and scattered from the displays, according to one or more embodiments of the present disclosure;

FIG. 10 is a plot of a washout performance metric as a function of water contact angle of the substrates prior to masking for Examples 1-5, according to one or more embodiments of the present disclosure;

FIGS. 11A, 11B, and 11C are plots showing AF curves for Examples 6-11 compared to a control formed with the same pattern without feature rounding, according to one or more embodiments of the present disclosure;

FIGS. 12A, 12B, and 12C are scanning electron microscope images of surface structures associated with Examples 9, 10, and 11, according to one or more embodiments of the present disclosure;

FIGS. 13A, 13B, 13C, and 13D are surface height profiles and histograms representing portions of samples associated with Examples 12-14 and a comparable control sample without feature rounding, according to one or more embodiments of the present disclosure;

FIG. 14 is a plot showing AF curves for Examples 12-14 and the control sample represented in FIG. 13A, according to one or more embodiments of the present disclosure;

FIG. 15 is a plot of bidirectional reflectance distribution function (“BRDF”) amplitude as a function of scattering angle for Examples 12-14 and the control sample, according to one or more embodiments of the present disclosure;

FIGS. 16A, 16B, 16C, and 16D are surface height profiles and histograms representing portions of samples associated with Examples 15-17 and a comparable control sample without feature rounding, according to one or more embodiments of the present disclosure;

FIG. 17 is a plot showing AF curves for Examples 15-17 and the control sample represented in FIG. 16A, according to one or more embodiments of the present disclosure;

FIG. 18 is a plot of bidirectional reflectance distribution function (“BRDF”) amplitude as a function of scattering angles for Examples 15-17 and the control sample, according to one or more embodiments of the present disclosure;

FIG. 19 is a surface height profile and histogram associated with another control sample without feature rounding that was tested for abrasion performance, according to one or more embodiments of the present disclosure;

FIG. 20 is a surface height profile and histogram associated with Example 23, according to one or more embodiments of the present disclosure;

FIGS. 21A and 21B are images of the samples represented in FIGS. 19 and 20 after undergoing abrasion testing, according to one or more embodiments of the present disclosure; and

FIG. 22 is a histogram of track visibility values calculated from images of the samples depicted in FIGS. 21A and 21B after abrasion testing, according to one or more embodiments of the present disclosure.

### DETAILED DESCRIPTION

Referring generally to the figures, described herein are articles comprising a surface with a scattering region comprising a plurality of structures. The structures extend outward from a base plane to a peak height in a direction perpendicular to the base plane. As a result of performance of the fabrication methods herein, each of the plurality of structures comprises a sloped portion extending from the base plane and a peak portion disposed at the peak height relative to the base plane. The scattering region is fabricated in accordance with the methods described herein such that the sloped portions of the plurality of structures in combination constitute at least 5% of the total surface area of the scattering region (projected into a plane extending parallel to the base plane). Applicant has found that the sloped portions making up such a large portion of the total surface area of the scattering region beneficially provides lower scattering amplitudes at a relatively high scattering angles (e.g., greater than or equal to 20° or greater than or equal to 30° relative to specular) relative to scattering regions where sloped portions are a smaller fraction of the total surface area. The approaches described herein also enable the plurality of structures to be designed to provide favorable combinations of anti-glare (“AG”) performance attributes. For example, the scattering regions described herein can be designed in the spatial frequency domain based on a target radial power spectral density (“PSD”) for the article and converting the target radial PSD to a phase profile (or “phase map”) that is used to form the plurality of structures via the etching methods described herein. The target radial PSD may be selected to achieve low washout (due to the sloped portions described herein) without compromising on other favorable AG performance attributes. For example, the articles described herein can achieve a transmission haze of less than 3.5% (or even less than or equal to 3.0%, less than or equal to 2.5%, less than or equal to 2.0%, less than 1.5% or less than 1.25%), coupled specular reflectance (Rs) of less than 15, and sparkle (as measured at 140 ppi) of less than 2.5%, all while exhibiting low washout (as described in greater detail herein).

The plurality of structures of the scattering regions described herein can be formed via a multi-step etching process. An initial etching step (described herein as the “primary etching step”) is performed using one or more patterned masks (e.g., formed using photolithography or any other suitable process described herein). For example, the patterned masks may cover regions of the first major surface of the article in an arrangement based on the phase mask generated using the target radial PSD. The masked article may then be exposed to a first etching solution so that uncovered regions of the first major surface are etched to a target etch depth and, after the initial etching step, the first major surface comprises a plurality of first regions disposed at a first average height relative to a base plane disposed at the etch depth and a plurality of second regions disposed at the base plane, with transition surfaces extending between the first and second regions. The first regions may represent unetched portions of the first major surface and the second regions can represent etched portions of the first major surface. After the initial etching step is complete, the plurality of structures can be formed via a completion of a secondary etching step. The secondary etching step may be performed using a dip or spray etching process and involves exposing the entire scattering region to a second etching solution that etches the material of the article at an etching rate of at least 0.1 μm/min for a time period of at least 1 minute. It has been found that the secondary etching step rounds out sharp corners present after the initial etching step and converts the transition surfaces to the sloped portions of the plurality of structures. The secondary etching step generally reduces a fill fraction associated with portions of the first major surface disposed at the initial etch depth relative to the base plane and increases the surface area percentage taken up by the sloped portions to provide the reduced-washout benefits described herein.

While alternative techniques exist for creating the sloped portions described herein, such as reducing adhesion between the mask and article during the initial etching step, as described herein, it has been determined that the multi-etch fabrication techniques described herein beneficially provide sloped portions that are more uniform in shape. The multi-etch fabrication technique is more predictable and repeatable than existing methods. This leads to more consistent optical properties that are able to be more particularly tailored for various applications. A further benefit of the multi-step etching process described herein is that the secondary etching step tends to round out corners at both the top and bottom of the transition surfaces of the article after the initial etching step. Adhesion control techniques are believed to not round out bottom corners and so articles formed using such techniques tend to possess sharper bottom corners, which is believed to be associated with inferior washout performance.

As will be further appreciated in view of the remaining description, the plurality of structures described herein can have a variety of different forms and shapes. While the plurality of structures described herein can generally be characterized as protrusions extending outward from the base plane away from the body of the article, the exact shape of the structures can vary. For example, in embodiments, at least some of the peak portions of the structures disposed at the peak height can comprise a surface area greater than or equal to 1 μm² so that the peak portions are planar-shaped regions of the first major surface. Alternatively or additionally, at least some of the peak portions comprise a smaller surface area (e.g., less than 0.25 μm²) so that at least some of the plurality of structures do not comprise any planar portions disposed at a constant height relative to the base plane. Irrespective of the precise shape of the structures described herein, the presence of the sloped portions has been determined to be associated with improved washout performance. In embodiments, the sloped portions may comprise slopes (in terms of height change relative to the base plane) that are less than or equal to 1.0 (e.g., greater than or equal to 0.01 and less than or equal to 0.3) to provide the optical performance benefits described herein.

Surface profiles of the scattering regions described herein can be characterized by generating an Abbott-Firestone (“AF”) curve for a randomly selected 1×1 mm² area of the scattering region. The AF curve can be generated by measuring a surface height profile of the scattering region with white light interferometry providing a lateral measurement resolution of less than or equal to 500 nm (e.g., 360 nm). Unless otherwise noted herein, AF curves contained herein are generated using a lateral resolution of 360 nm per pixel detector, using a 50× objective lens with a numeral aperture of 500 nm. The surface height profile can then be used to generate a histogram of the surface height at each pixel in the data set. The histogram can then be integrated to generate the AF curve. AF curves for the scattering regions according to the present disclosure include a first portion representing an area of the scattering region disposed most proximate to the base plane, a second portion representing peak portions of the plurality of structures, and an intermediate portion extending between the first portion and the second portion. The first and second portions of the AF curve can vary. In embodiments, the AF curve can be characterized as including first and second vertical portions of relatively high slope (e.g., greater than or equal to 350%/μm, including undefined slopes). The intermediate portion can comprise a slope that is less than the first and second portions and greater than or equal to 5%/μm. The lengths of the vertical portions and intermediate portions can vary depending on the etch depth in the primary etching step and the extent of material removal in the secondary etching step described herein. Moreover, the number of vertical portions and intermediate portions can vary depending on the number of sub-etching steps performed in the primary etching step (e.g., two sub-etching steps can be performed so that the first major surface comprises features disposed primarily at four heights based on etch depths used in each sub-etching steps, so that the AF curve comprises four vertical portions and three intermediate portions). Characterizing the sloped portion via AF curve provides a representation of the surface area percentage occupied by various surface heights. The intermediate portions having slopes within the range described herein indicates a level of feature rounding to provide the improved washout performance described herein.

A beneficial aspect of the sloped portions described herein is that the articles can exhibit improved abrasion performance. It is believed that sharp features such as corners can be broken off when the scattering regions are abraded by particulate debris, which can lead to visible damage. The scattering regions of the present disclosure lack such sharp features and the sloped portions allow for dispersal of forces when abrasive particles (e.g., dirt, dust, other debris) are pressed against the first major surface, rendering visible damage less likely. This improved abrasion performance is particularly beneficial when the articles are subjected to repeated contact from users (e.g., when the articles are used as a protective cover for a touch screen). Indeed, as described herein, when the articles according of the present disclosure are subjected to CS8 abrasion testing, they exhibit less visible track damage than comparable articles without rounded features. This demonstrates that the articles described herein exhibit improved durability for touch applications.

A context where the articles described herein may be particularly useful is in the context of vehicle interior displays. Vehicle interiors may include one or more displays (e.g., center counsel displays, dashboard displays, pillar displays, seatback displays, and others). Such displays may be fixed in orientation relative to the driver. When in operation, vehicles are subject to ambient light conditions that can cause relatively severe glare. For example, sunlight can enter the vehicle interior through a side window or windshield and reflect or scatter off of the displays, causing bright glare that can distract the driver and degrade performance of the display due to washout. The articles described herein may reduce such washout from commonly encountered ambient light conditions. Such favorable washout performance may be achieved while also providing favorable sparkle and transmission haze performance.

As used herein, the term “target radial PSD” refers to a target radial PSD for a scattering region that is calculated mathematically from a desired far-field scattering pattern of the surface.

As used herein, “specular reflectance (Rs)” or “Rs” is defined as the peak intensity of light reflected from a first surface of a substrate within a cone of angles of +/−0.1°. Unless otherwise noted herein specular reflectance is measured using a Rhopoint IQ meter, which reports an Rs value that is in Gloss Units.

Articles described herein may be characterized by a distinctness-of-image value. “Distinctness-of-reflected image,” “distinctness-of-image,” “DOI” or like term is defined by method A of ASTM procedure D5767 (ASTM 5767), entitled “Standard Test Methods for Instrumental Measurements of Distinctness-of-Image Gloss of Coating Surfaces.” In accordance with method A of ASTM 5767, glass reflectance factor measurements are made on the at least one roughened surface of the glass article at the specular viewing angle and at an angle slightly off the specular viewing angles (from 0.2° to 0.4° away from specular). Such measurements can be made using a goniophotometer (Rhopoint IQ (Goniophotometer) 20°/60°/85°, Rhopoint Instruments) that is calibrated to a certified black glass standard, as specified in ASTM procedures D523 and D5767.

As used, herein, the term “haze” or “transmission haze” refers to the percentage of transmitted light scattered outside an angular cone of about ±2.5° in accordance with ASTM D1003, entitled “Standard Test Method for Haze and Luminous Transmittance of Transparent Plastics,” the contents of which are incorporated by reference herein in their entirety. Note that although the title of ASTM D1003 refers to plastics, the standard has been applied to substrates comprising a glass material as well. For an optically smooth surface, transmission haze is generally close to zero.

As used herein, the terms “sparkle,” “sparkle contrast,” “display sparkle,” “pixel power deviation,” “PPD”, or like terms refers to the visual phenomenon that occurs when a textured transparent surface is combined with a pixelated display. Generally speaking, quantization of sparkle involves imaging a lit display or simulated display with the textured surface in the field of view. The calculation of sparkle for an area P is equal to σ(P)/μ(P), where σ(P) is the standard deviation of the distribution of integrated intensity for each display pixel contained within area P divided by the mean intensity μ(P). Following the guidance in: (1) J. Gollier, et al., “Apparatus and method for determining sparkle,” U.S. Pat. No. 9,411,180B2, 20 Jul. 2016; (2) A. Stillwell, et al., “Perception of Sparkle in Anti-Glare Display Screens,” JSID 22 (2), 129-136 (2014); and (3) C. Cecala, et al., “Fourier Optics Modeling of Display Sparkle from Anti-Glare Cover Glass: Comparison to Experimental Data”, Optical Society of America Imaging and Applied Optics Congress, JW5B.8 (2020); one skilled in the art can build an imaging system to quantify sparkle. Alternatively, a commercially available system (e.g. the SMS-1000, Display Messtechnik & Systeme GmbH & Co. KG, Germany) can also be used. Unless described otherwise, sparkle is measured with a 140 PPI display using the following procedure. A 140 PPI display (e.g. Z50, Lenovo Group Limited, Hong Kong) with only the green subpixels lit (R=0, B=0, G=255), at full display brightness is imaged using a f=50 mm lens/machine vision camera combination (e.g. C220503 1:2.8 50 mm Φ30.5, Tamron, Japan) and Stingray F-125 B, Allied Vision Technologies GmbH, Germany). The lens settings are aperture=5.6, depth of field=0.3, working distance=about 290 mm; with these settings, the ratio of display pixels to camera pixels is approximately 1 to 9. The field of view for analysis contains approximately 7500 display pixels. Camera settings have the gain and gamma correction turned off. Periodic intensity variations from, e.g. the display, and non-periodic intensity variations, e.g. dead pixels, are removed during analysis prior to the calculation of sparkle.

Anti-glare performance can be measured with nothing coupled to the surface (herein described as “uncoupled”) or a black absorber coupled to a rear surface of the glass (herein described as “coupled”).

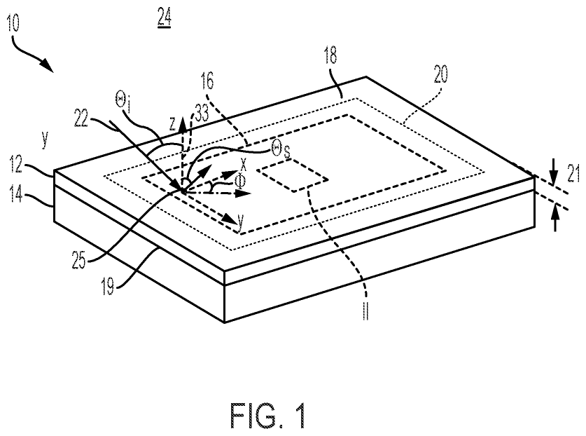

Referring now to FIG. 1, an article 10 is depicted, according to an example embodiment. The article 10 comprises a substrate 12. In the depicted embodiment, the article 10 is a display article (e.g., a display cover article) and further includes a housing 14 to which the substrate 12 is coupled and a display 16 within the housing 14. In such embodiments, the substrate 12 at least partially covers the display 16 such that light that the display 16 emits can transmit through the substrate 12.

The substrate 12 may be a variety of materials depending on the implementation. For example, in embodiments, such as in the embodiment depicted in FIG. 1, the substrate 12 is a glass or glass-ceramic substrate. Various properties and examples for such glass or glass-ceramic substrates are described in greater detail herein. In embodiments, the substrate 12 may be constructed of a material other than glass such as paper, plastic or other suitable polymeric material. In embodiments, the substrate 12 can include a combination of glass and polymeric materials. In an example, the scattering region 20 described herein is formed in a layer of polymeric material formed on a glass substrate. In embodiments, the substrate 12 is transparent, or exhibits an average transmittance for light normally incident on the substrate 12 that is in a wavelength range of 400 nm to 700 nm of greater than or equal to 70% (e.g., greater than or equal to 80%, greater than or equal to 85%, greater than or equal to 90%, greater than or equal to 92%, greater than or equal to 92.5%, greater than or equal to 93%). In embodiments, the substrate 12 is opaque or exhibits an average transmittance for light normally incident on the substrate that is in a wavelength range of 400 nm to 700 nm that is less than or equal to 30%. In embodiments, the substrate 12 is tinted to exhibit a colored appearance under ambient illumination (e.g., from sunlight).

The substrate 12 includes a first major surface 18, a second major surface 19, a scattering region 20 defined on the first major surface 18, and a thickness 21 that the first major surface 18 bounds in part (e.g., representing a minimum distance between the first major surface 18 and the second major surface 19 at a particular point on the first major surface 18). In the depicted embodiment, the substrate 12 is substantially planar in shape such that the first major surface 18 and the second major surface 19 are generally flat (with the exception of plurality of surface features formed in the first major surface 18 in the scattering region 20, as described herein). Embodiments where the substrate 12 comprises a curved shape (e.g., via suitable hot-forming and cold-forming techniques) are also contemplated and within the scope of the present disclosure. In such embodiments, references to the “surface normal” (depicted as the surface normal 33 in FIG. 1) herein are to a local surface normal at a point where light from an external environment 24 is incident on the first major surface 18. In the depicted embodiment, the first major surface 18 generally faces toward the external environment 24 surrounding the article 10 and away from the display 16. In embodiments, the display 16 emits visible light that transmits through the thickness 21 of the substrate 12, out the first major surface 18, and into the external environment 24.

As depicted in FIG. 1, light from the external environment 24, represented by incoming light ray 22, may be incident on the first major surface 18 at an angle of incidence Θᵢ (representing a zenith angle that the incoming light ray 22 extends relative to the surface normal 33 of the first major surface 18, depicted as the z-direction in FIG. 1). The incoming light ray 22 may represent light from a number of different sources from outside of the article 10. For example, the incoming light ray 22 may represent sunlight that is incident on the first major surface 18 or light from another external light source (e.g., light reflected or scattered from an external object, light generated by another source). The scattering region 20 scatters the light represented by the incoming light ray 22 in a scattering direction, represented by the scattered light ray 25. Light is scattered in a particular direction with a scattering amplitude that depends on the angle of incidence Θᵢ and a scattering angle Θₛ relative to the surface normal 33. As shown, the scattered light ray 25 is scattered in a scattering direction that, when projected into a plane of the first major surface 18 extending perpendicular to the surface normal 33, extends at an azimuthal angle Φ relative to a first direction (the x-direction depicted in FIG. 1).

In embodiments, the scattering region 20 is designed based on a target radial PSD. The target radial PSD can be azimuthally averaged with respect to the azimuthal angle Φ such that the PSD is statistically isotropic with respect to the azimuthal angle. Irrespective of the azimuthal angle Φ, the target radial PSD varies with the zenith angle Θₛ in accordance with the same functional relationship. Such a target radial PSD beneficially minimizes the effects of rotational orientation of the article 10 in the external environment 24 on AG performance.

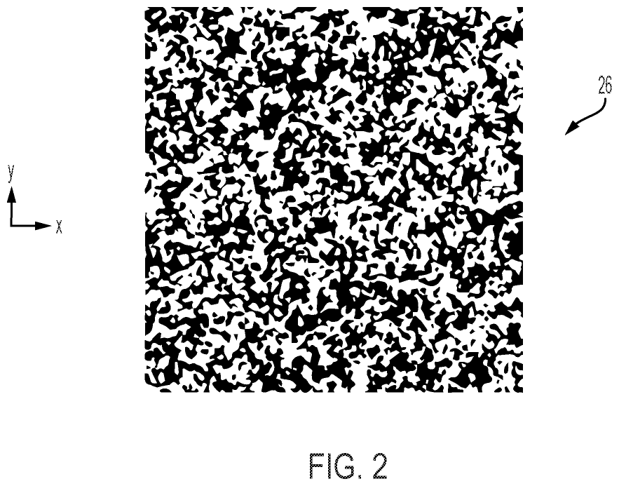

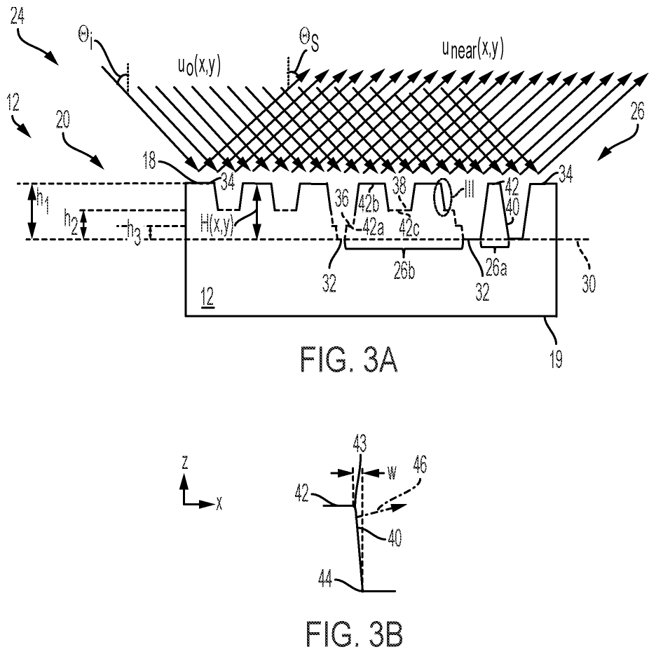

FIG. 2 schematically depicts a plan view of the region II of the scattering region 20 of the article 10 depicted in FIG. 1, according to an example embodiment of the present disclosure. As shown, the scattering region 20 comprises a plurality of structures 26. The plurality of structures 26 generally vary in size and peripheral shape, and comprise lengthwise axes that extend in a plurality of different directions in a plane parallel to the base plane 30 (see FIG. 3A). However, randomness in the structure of the plurality of structures 26 differs from that in certain existing AG surfaces (e.g., produced by sandblasting) in that the arrangement of the plurality of structures 26 is reproducible (within a manufacturing tolerance) via the methods described herein.

In embodiments, the plurality of structures 26 are designed based on a target radial PSD in the Fourier domain, as described herein. In embodiments, the plurality of structures 26 comprise features that protrude outward from a base plane defined by portions of the first major surface 18. For example, FIG. 3A depicts a cross-sectional view of the scattering region 20 depicted in FIG. 2. As shown, the article 10 includes a base plane 30 representing the portions of the first major surface 18 that are disposed most proximate to the second major surface 19. The base plane 30 generally represents the portion of the first major surface 18 that contacts one or more first etching solutions of a primary etching step described herein. That is, the base plane 30 represents areas where the most material of the substrate 20 is removed during the primary etching step. For example, the primary etching step can only include one sub-etching step and, in such embodiments, the base plane 30 can represent areas of the first major surface 18 that were uncovered by an etching mask during the primary etching step.

In embodiments, the primary etching step can be controlled so that a plurality of first portions 32 of the first major surface 18 are substantially planar and disposed in the base plane 30 (or within tolerance that is less than 1% of the etch depths described herein from the base plane 30). For example, in embodiments, within a particular one of the plurality of first portions 32, the surface height variation (or roughness) may be less than 50 nm, in terms of root-mean-square (RMS) variation (or less than 20 nm RMS, or less than 10 nm RMS). For example, in these embodiments, each of the plurality of first portions 32 of the first major surface 18 can be characterized by a surface height variation from 0.1 nm RMS to 50 nm RMS, from 0.1 nm RMS to 20 nm RMS, from 0.1 nm RMS to 10 nm RMS, or from 0.1 nm RMS to 1 nm RMS. In some embodiments, the peak portions 42 can exhibit similar surface roughness characteristics (e.g., when not completely rounded).

As shown in FIG. 3A, the plurality of structures 26 generally comprise protrusions where the first major surface 18 extends outward from the base plane 30 away from the second major surface 19. Each of the plurality of structures 26 can be differently shaped (e.g., comprise a different peripheral shape) and/or comprise a different number of sub-structures. In the example shown in FIG. 3A, a first structure 26a comprises a pillar that protrudes from the base plane 30 and comprises no intermediate sub-structures. A second structure 26b, in contrast to the first structure 26a, comprises sub-structures where the curvature or surface shape of the first major surface 18 abruptly changes in areas other than at the external boundaries of the structure or at a peak portion thereof, as described herein. In the depicted example, the second structure 26b comprises a first sub-structure 36 and a second sub-structure 38, which are substantially planar portions of the first major surface 18 disposed at different heights h₂ and h₃ relative to the base plane 30. Such sub-structures can result from multiple sub-etching steps in the primary etching step described herein.

In embodiments, the first major surface 18 comprises a plurality of different regions disposed at different heights relative to the base plane 30. The surface height profile of the scattering region 20 can form a multimodal height distribution relative to the base plane 30, where, in some cases, the number of modes is determined based on a number of sub-etching steps performed in the primary etching step described herein or the extent of material removal during the secondary etching step. Each mode of the multimodal height distribution can be characterized by a distinct peak in a histogram of surface height occurrences generated from a surface height profile obtained from a white light interferometry measurement. In an example where the primary etching step only includes a single sub-etching step, the surface height profile of the scattering region 20 can form a bi-modal height distribution, where the histogram comprises two distinct peaks: one associated with the plurality of first portions 32 disposed in the base plane 30 and one associated with a plurality of second portions 34 disposed at a first heigh h₁ relative to the base plane h₁. The plurality of second portions 34 can represent portions of the first major surface 18 that are not etched during the primary etching step described herein. As a result, h₁ can correspond to the etch depth selected for the primary etching step. In examples where the primary etching step includes multiple sub-etching steps, the surface height profile of the scattering region 20 can form a multimodal height distribution with at least 3 modes, or at least 3 distinct peaks in the histogram (the secondary etching step described herein can render multiple intermediate peaks indistinct from one another). In such embodiments with multiple sub-etching steps, h₁ can represent a summation of the etch depths associated with each of the individual sub-etching steps in the primary etching step described herein.

Each of the plurality of structures 26 (or sub-substructure therein) comprises a sloped portion 40 and a peak portion 42 disposed at a peak height associated with that structure (or sub-structure). In the sloped portion 40, a surface height of the first major surface 18 increases with increasing lateral distance away from a nearest one of the plurality of first portions 32. An average slope of the first major surface 18 within the sloped portions 40 may be greater than the average slope within the plurality of first portions 32. Within the sloped portion 40, the first major surface can have a slope that ranges from 0.01 and less than or equal to 0.1 as a function of lateral position in a direction perpendicular to a surface normal of the sloped portion 40. In embodiments, for example, the sloped portions 40 comprise regions of the first major surface 18 where the surface height varies by greater than or equal to 10 nm per 1 μm of linear distance and less than 100 nm per μm of linear distance measured in a direction extending perpendicular to the sloped portion 40, where the linear distance is measured in a plane parallel to the base plane 30. As a result of the sloped portions 40 having such slopes, sharp features (e.g., corners) of the first major surface 18 are eliminated, which aids in reducing scattering amplitudes at relatively high scattering angles.

The peak portions associated with each of the plurality of structures 26 (and associated sub-structures) can vary in shape. In depicted embodiment, for example, the peak portion 42 is a substantially planar portion disposed at the height h₁ relative to the base plane 30. In alternative embodiments, at least some of (if not all of) the plurality of structures 26 do not include any planar portions (the tops of the structures may be completely rounded as a result of the secondary etching process described herein) and, as a result, the peak portion 42 can comprise a single point on the substructure disposed at the peak height. Additionally, the peak heights of adjacent ones of the plurality of structures 26 need not be identical to one another. For example, as shown in FIG. 3A, the second structure 26b comprises a first peak region 42a disposed at the height h₃ relative to the base plane 30, a second peak region 42b disposed at the height h₁ relative to the base plane 30, and a third peak region 42c disposed at the height h₃ relative to the base plane 30. The arrangement of surface heights of the peak portions 42 is generally determined by patterns associated with one or more etching masks used in the primary etching step described herein.

It has been found that superior washout and mechanical abrasion performance described herein can be provided when the sloped portions 40 of the plurality of structures 26 account for at least 5% (or even at least 10%, or even at least 15%, or even at least 20%, or even at least 30%, or even at least 40%, or even at least 50%) of a total surface area of the scattering region 20 (projected into the base plane 30). That is, when the scattering region 20 is viewed facing the first major surface 18 in a direction perpendicular to the base plane 30, the sloped portions 40 account for at least 5% of the total surface area of the scattering region 20. The uniformity of the sloped portions (e.g., in terms of slope and transition width) described herein provided by the multi-step etching process described herein can aid in achieving this area fraction and can ensure uniform washout reduction irrespective of particular location within the scattering region 20.

The sloped portions 40 can also be characterized by a lateral transition width w over which the first major surface 18 transitions between modes in a multimodal height distribution associated with a surface height profile of the scattering region 20. With reference to FIG. 3B, in embodiments, each of the sloped portions 40 comprises a first edge 43 disposed proximate to a peak portion 42 and a second edge 44 disposed adjacent to a feature of lower surface height (e.g., one of the plurality of first portions 32). As shown in FIG. 3B, the sloped portion 40 may comprise a width w. The width w is measured as a lateral distance in a plane parallel to the base plane 30 (the x-y plane depicted in FIGS. 1-2) between the first edge 43 and the second edge 44. The lateral distance is also measured in a direction extending parallel to a projection of a surface normal 46 of the sloped portion 40 into the x-y plane. In embodiments, the width w is greater than or equal to 1.0 μm and less than or equal to 10.0 μm (e.g., greater than or equal to 1.0 μm and less than or equal to 9.0 μm, greater than or equal to 1.0 μm and less than or equal to 8.0 μm, greater than or equal to 1.0 μm and less than or equal to 7.0 μm, greater than or equal to 1.0 μm and less than or equal to 6.0 μm, greater than or equal to 1.5 μm and less than or equal to 6.0 μm, greater than or equal to 2.0 and less than or equal to 6.0 μm, greater than or equal to 3.0 μm and less than or equal to 10 μm). Widths within such ranges indicate a lack of sharpness in transitions of the slope of the first major surface 18. Rather than relatively sharp corners at the first and second edges 43 and 44, the first major surface 18 transitions between slopes gradually (e.g., as in a rounded corner). As described in greater detail herein, such feature rounding aids in reducing high spatial frequency content in the radial PSD of the scattering region 20, thereby providing favorable washout performance. Unless otherwise specified, the width w is a maximum measured value for the lateral distance over a particular transition surface.

The width w can be measured in a variety of different techniques. For example, the width w may be physically measured by generating line profiles of the first major surface 18. The line profiles may be generated by surface height measurements of the first major surface 18 via white light interferometry. Line profiles may also be obtained by other known methods (e.g., using a scanning electron microscope, an atomic force microscope, or a stylus profilometer). The images are sampled in directions extending perpendicular to the sloped portion 40 at a point where the width w is being measured (in a direction extending parallel to a projection of the surface normal 46 into the x-y plane, with that surface normal being located at the first edge 43). The width w at a particular point on a sloped portion 40 is calculated as a minimum lateral distance between points disposed at heights that differ from one another by within 10% of a difference between heights associated with adjacent peaks in the multimodal height distribution. The particular modality used to image the first major surface 18 in measuring the width w may vary depending on the size of the width w. When the width is less than 2.0 μm, atomic force microscopy may be used to image the first major surface 18. When the width w is greater than or equal to 2.0 μm, line profiles may be extracted from white light interferometer data, as described herein. The resulting width w may be measured as the minimum lateral distance between points disposed at heights that differ from one another by within 10% of a difference between adjacent heights in the multimodal height distribution.

Referring again to FIG. 3A, the physical structure of the plurality of structures 26 may be determined using a Fourier analysis of diffraction. As shown in FIG. 3A, incoming radiation from the external environment 24 may be approximated as uniform planewave expressed as

u₀(x,y)=\sqrt{I₀}e^{i(k}^{ₓ₀}^{x+k}^{_{y0}}^{y)} (1)

where Iₒ represents a uniform intensity of incoming radiation and kₓ₀ and k_{y0} represent wave vector components associated with the wavelength and angle of incidence of incoming radiation on the first major surface 18 (e.g., the angle of incidence may be broken up into components in x-z and γ-z planes depicted in FIG. 1). In such a case, the scalar near field for the outgoing radiation (after interaction with the first major surface 18) can be approximated as

uₙₑₐᵣ(x,y)=ρu₀(x,y)·e^{iφ(x,y)} (2)

where ρ is the Fresnel coefficient of the interface, and

$$ϕ ( x , y ) = \frac{2 π}{λ} 2 H ( x , y )$$

is the local phase accumulated through the double passage of the distance to the first major surface 18 and H(x,y) represents the pattern formed by the plurality of structures 26. In this example, incoming radiation is approximated as having a uniform intensity distribution and the interface between the substrate 12 and the external environment 24 is approximated as only applying a spatially varying phase such that the outgoing radiation in the near field also has a uniform intensity distribution.

In this example depicted in FIG. 3A, the far field scattering pattern associated with the outgoing radiation may be represented in spatial frequency (k) space and is related to the near field uₙₑₐᵣ(x, y) computed using Equation 3 through a Fourier transform and expressed as

u_{far}(kₓ,k_{y})= [symbol] [uₙₑₐᵣ(x,y)]=∫∫dxdye^{-i(k}^{ₓ}^{x+k}^{_{y}}^{y)}uₙₑₐᵣ(x,y) (3),

where kₓ and k_{y} represent scattering vector components (kₓ=|k|*cos(Φ), k_{y}=|k|*sin(Φ))), where k is expressed as

$$k = 2 π \frac{sin {θ}_{s}}{λ} , \qquad ( 4 )$$

Φ is the azimuthal angle depicted in FIGS. 3, and λ is the wavelength of the scattered radiation. As used herein, the “PSD” of the scattering region 20 is expressed as

$$P S D ( k ; λ ) = \frac{1}{A} {\vert {u}_{far} \vert}^{2} \qquad ( 5 )$$

where A is the area of the scattering region 20. As used herein, the term “target radial PSD” refers to Equation 5 when averaged over the full range of azimuthal angles Φ. The target radial PSD is expressed as an azimuthally averaged PSD (<PSD>_{Φ}) using the following equation:

$${〈 P S D 〉}_{Φ} ( \vert k \vert ; λ ) = \frac{1}{2 π} {\int }_{0}^{2 π} P S D ( k ; λ ) d Φ . \qquad ( 6 )$$

As such, target radial PSDs only depend on the magnitude of the spatial frequency and the wavelength of the scattered radiation. Unless expressed otherwise, radial PSDs are expressed assuming a wavelength of 550 nm. The term “target radial PSD” refers to the result computed from Equation 6. In embodiments, the plurality of structures 26 are structured so that H(x,y), when input into Equation 2, substantially matches a target radial PSD. An example family of target radial PSDs that can be used to design the scattering region 20 can be expressed as

$$PSD ∼ {( \frac{{k}_{max} - k}{{k}_{max} - {k}_{peak}} )}^{α} \qquad ( 7 )$$

where α is an exponential decay parameter, kₘₐₓ is a spatial frequency associated with a non-zero scattering angle Θₘₐₓ at which the target radial PSD is equal to zero, and kₚₑₐₖ is a spatial frequency associated with a peak angle Θₚₑₐₖ at which the target radial PSD has a peak value. Assuming a wavelength of 550 nm, different values for the parameters α, Θₘₐₓ, and Θₚₑₐₖ can be used to generate target radial PSDs that provide different performance attributes. Guidance on parameter selection for particular combinations of performance attributes can be found in U.S. Provisional Patent Application No. 63/420,222, filed on Oct. 28, 2022, hereby incorporated by reference in its entirety.

Once a suitable target radial PSD is identified, the target radial PSD can be used to determine a phase distribution

$$ϕ ( x , y ) = \frac{2 π}{λ} 2 H ( x , y )$$

for the first major surface 18 using the methods described herein. For example, an inverse Fourier transform of the target radial PSD may be used to generate the phase map. Such an approach may generally produce a complex-valued phase map that is non-binary (and thus not consistent with a surface having a bimodal height distribution, such as the one illustrated in FIG. 3). Non-binary phases are problematic in that certain existing production processes, such as the etching methods described herein, are not capable of producing such structures. Accordingly, a threshold can be applied to the phase map such that discrete regions (“pixels”) of the phase map form a discrete distribution of phases. The imaginary terms of the phases generated may be discarded and the threshold may be applied to the real values such that pixels having an average value below the threshold are assigned a first phase (e.g., λ/2) and pixels having an average value above the threshold are assigned a second phase (e.g., −π/2). In embodiments the value for the threshold is selected such that an equal number of pixels are calculated to have a first phase and a second phase (e.g., each phase occupies 50% of the surface area of the scattering region). The pixel size may be selected based on an estimated minimum feature size achievable via the etching process described herein. In embodiments, the pixel size is greater than or equal to 200 nm (e.g., greater than or equal to 300 nm, greater than or equal to 400 nm, greater than or equal to 500 nm, greater than or equal to 600 nm, greater than or equal to 700 nm, greater than or equal to 800 nm, greater than or equal to 900 nm, greater than or equal to 1000 nm).

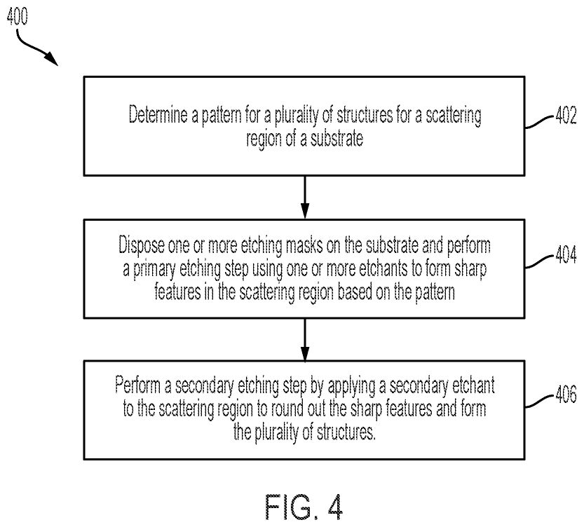

FIG. 4 depicts a flow diagram of an example method 400 of fabricating the article 10, according to an example embodiment of the present disclosure. Reference to various components and processes depicted in FIGS. 1-3B will be made to aid in describing the method 400. The method used to form the article 10 is not particularly limiting and that any suitable method may be used. At block 402, a pattern for the plurality of structures 26 is determined. In embodiments, the pattern is determined via the techniques described herein with respect to FIGS. 3A-3B, i.e., by selecting a target radial PSD, generating a phase map based on the target radial PSD, and thresholding the generated phase map.

At block 404, one or more etching masks is disposed on the substrate 12 and a primary etching step is performed using one or more etchants to form sharp features in the scattering region based on the pattern determined at the block 402. For example, to form a first one of the one or more etching masks, a resist can be disposed on the first major surface 18 and patterned. The nature of the deposition and patterning of the resist may vary depending on the fabrication technique used. In embodiments, various nanoimprint or photolithographic techniques may be used to deposit and pattern the resist layer. In such embodiments, a minimum feature size (e.g., minimum linear dimension) associated with the plurality of structures 26 may be set to at least 400 nm, (e.g., greater than or equal to 500 nm, greater than or equal to 600 nm, greater than or equal to 700 nm, greater than or equal to 800 nm, greater than or equal to 900 nm, greater than or equal to 1.0 μm, greater than or equal to 1.5 μm, greater than or equal to 2.0 μm, greater than or equal to 2.5 μm, greater than or equal to 5.0 μm) to facilitate use of existing resist application and patterning techniques. In embodiments, for example, the resist may be formed using thermoplastic nanoimprint lithography, and the resist may be formed of a thermoplastic polymer that is spin-coated onto the substrate 12 and subsequently imprinted via a mold to form a first pattern that at least partially corresponds to the pattern for the plurality of structures 26 on the first major surface 18. The resist may be subsequently thermally cured to form an etching mask. Other methods of forming the resist (e.g., Gravure offset printing, other printing techniques) are also contemplated and within the scope of the present disclosure.

Photolithography (e.g., photo imprint nanolithography, optical photolithography) techniques may also be used, and the resist may be deposited onto the first major surface 18 via a suitable application method (e.g., spin coating). In such embodiments, a mask comprising a first pattern at least partially corresponding to the pattern determined for the plurality of structures 26 is aligned with the first major surface 18, and the resist may be exposed to radiation from a suitable light source (e.g., UV radiation) to cause the resist to cure and form an etching mask. The resist may subsequently be developed such that portions of the first major surface 18 are left exposed through the cured resist. Any suitable photolithographic technique may be used to pattern the resist.

After the resist is patterned, exposed areas of the first major surface 18 (through the cured and patterned resist) are exposed to a suitable etchant for a suitable etching period determined based on a target etch depth in the primary etching step. Each area of the first major surface 18 that is exposed through the patterned resist may directly contact the etchant, which may degrade the substrate 12 and remove material therefrom. In embodiments, the etchant that contacts the first major surface 18 is an HF/HNO₃ etchant. In embodiments, the etchant consists of hydrofluoric acid (HF, 49 w/w %) and nitric acid (HNO₃, 69 w/w %) combinations with 0.1-5 v/v % HF and 0.1-5 v/v % HNO₃. Typical concentrations used to achieve the etching depths discussed herein are 0.1 v/v % HF/1 v/v % HNO₃ to 0.5 v/v % HF/1 v/v % HNO₃ solutions. In embodiments, the etching can be carried out using a dip or spray etching process from room temperature to about 45 °C.

The primary etching step can include any suitable number of sub-etching steps, with each sub-etching step including exposing different areas of the first major surface 18 to an etchant through a distinct mask. For example, the primary etching step can include two sub-etching steps, wherein a first etching mask is deposited and patterned on the first major surface 18 and a first set of areas are exposed to an etchant to etch the first areas to a first etching depth. After removal of the first etching mask, a second etching mask can be deposited and patterned on the first major surface 18 to facilitate exposing second areas of the first major surface 18 to an etchant to etch the second areas to a second etching depth relative to the heights obtained after the first sub-etchings steps. The pattern for the second etching mask may be determined in a manner similar to the first etching mask. For example, in embodiments, the same target radial PSD may be used to generate the pattern for the second etch as that was used in the first etch step. However, when the resist is disposed on the first major surface 18, the substrate 12 may be rotated by an angle (e.g., 90°, 180°, or any other angle) so that the pattern is applied to the first major surface 18 at a different orientation in the second etch as compared to the first etch. Alternatively, a different target radial PSD may be used to generate the pattern for the second etch than what was used in the first etch.

The first and second areas exposed to etchants in the first and second sub-etching steps, may be arranged so that the first and second sub-etching steps result in the surface height profile having a four mode distribution (with four distinct surface height peaks in terms of occurrence in a histogram generated from white light interferometry data). Embodiments are envisioned where even more than two sub-etching steps are performed to provide even higher numbers of modes. It has been found that providing at least four modes in the surface height profile can provide certain performance improvements relative to single sub-etch step designs, such as improved specular reflectance reduction and reduced DOI. The multiple levels enable interferometric suppression of specular reflection over a broader range of optical wavelengths. Performance attributes for multi-level designs will be described in more detail herein with respect to the Examples.

The primary etching step at the block 404 is generally performed so that sharp features are formed in the scattering region. By “sharp” it is meant that the areas exposed to etchant during the etchant step are uniformly removed so as to create a multi-level surface structure comprising a plurality of substantially planar-shaped regions disposed at different heights relative to the base plane 30 (adjacent heights can differ from one another by 20 nm to 200 nm in a direction perpendicular to the base plane 30), with transition surfaces extending between each of the levels extending substantially perpendicular to the base plane 30 (i.e., such that the first major surface 18 lacks the sloped portions 40). Such sharpness is generally attained my promoting adhesion between the resist and the substrate 12 to prevent undercutting of the resist during the primary etching step. In embodiments, an adhesion promoter (e.g., HexaMethylDiSilazane (HDMS) or N,N-dimethyl-N-(3-(trimethoxysilyl) propyl) octadecan-1-ammonium chloride, YSAM C18) is applied to the first major surface 18 prior to the resist being applied. In embodiments, any of the adhesion promoters described in U.S. Pat. No. 9,884,782, filed on Apr. 1, 2015, and hereby incorporated by reference in its entirety, can be applied to the glass prior to deposition of the resist in the primary etching step. Such adhesion promotor generally exhibits a dual adhesive or attractive functionality where one portion of the agent is attractive to the substrate 12 and another portion of the agent is attracted to the photoresist material. For certain articles described herein, it has been found that providing an adhesion promoter on the first major surface 18 that exhibits a water contact angle (after deposition) that is greater than or equal to 65° (prior to deposition of a risk or other masking material) should provide features of sufficient sharpness. The water contact angle to exhibit sharp features can vary depending on the adhesion promoter used. For example water contact angles of at least 75° (e.g., at least 80°) have been found to be sufficient when HDMS was used as an adhesion promoter, whereas water contact angles of at least 90° have been found to be sufficient when YSAM C18 was used. Any other method capable of providing sharp features without significant feature rounding can also be used. Such sharpness indicates high adhesion between the resist and substrate 12, which allows for precise control of the shape of the features formed in the first major surface 18 during the primary etching step, and therefore control over the optical performance of the scattering region 20.

Referring still to FIG. 4, after the primary etching step is complete, a secondary etching step is performed at block 406 by applying a secondary etchant to the scattering region 20 to round out the sharp features and form the plurality of structures. In the secondary etching step, an entirety of the scattering region 20 can come into direct contact with the secondary etchant after removal of the masks used in the primary etching step. It has been found that such a secondary etching step rounds out sharp features (e.g., corners) in the article 10 to provide the improved washout performance described herein. The secondary etching step can be done using any suitable etching process, such as a dip process or a spray process. For example, in a dip process, the article can be dipped into a secondary etching solution comprising a concentration ratio of HF and HCl from 0.5M HF/0.5M HCl to 3M HF/3M HCl, such that an etching rate of the article is greater than 0.1 μm/min or greater than 0.5 μm/min. In such embodiments, the article can be exposed to the secondary etching solution for a time period of at least 1 minute (e.g., greater than or equal to 1 minute and less than or equal to 30 minutes, greater than or equal to 1 minute and less than or equal to 20 minutes, greater than or equal to 5 minutes and less than or equal to 20 minutes). In a spray process, the article 10 can be sprayed with a secondary etching solution comprising a concentration ratio of HF and HCl from 16 mM HF/20 mM HCl to 160 mM HF/200 mM HCl to achieve an etching rate from 0.1 μm/min to 1 μm/min for a time period of at least 1 minute (e.g., greater than or equal to 1 minute and less than or equal to 30 minutes, greater than or equal to 1 minute and less than or equal to 20 minutes, greater than or equal to 5 minutes and less than or equal to 20 minutes). It has been found that such time periods and concentrations provide suitable amounts of feature rounding for improved washout performance.

Without wishing to be bound by theory, it is believed that the secondary etching process results in feature rounding due to variable etching rates at various regions of the sharp features formed at block 404. Based on computational fluid dynamics modelling, it is believed that convex corners (e.g., at the first edge 43 depicted in FIG. 3B) experience a greater etching rate than flat regions of the first major surface 18 (e.g., the plurality of first portions 32) because the convex corners exhibit the largest area per unit volume that is exposed to the secondary etchant, providing a greater area for the etching reaction to occur. Moreover, the exposed structure of the convex corner facilitates a better supply of reactant, leading to maintained high acid concentration in that region. Concave corners (e.g., at the second edge 44 depicted in FIG. 3B), in contrast, have relatively lower surface area per unit volume and a limited reactant supply, leading to a lower etching rate. Flat surfaces are believed to exhibit a moderate etching rate (between the convex and concave corners) due to improved reactant supply in the open space (relative to the concave corners), despite having a relatively low surface area-to-volume ratio.

An alternative method for providing rounded features is to forego the secondary etching step at the block 406 and to instead reduce adhesion between the resist and the substrate 12 during the primary etching step performed at block 404. For example, modifying the surface chemistry of the adhesion promoter described herein (in terms of hydrophobic groups) can provide a degree of control over undercutting during etching and feature rounding. Alternatively or additionally, the amount of adhesion promoter applied to the surface can also effect the amount of adhesion. Adhesion promoter can also be removed from the first major surface 18 prior to applying a resist thereto to modify adhesion of the resist. Applicant has found that modifying the water contact angle of the first major surface 18 prior to masking can modify the adhesion with the resist and therefore effect the amount of feature rounding. For example, it has been found that depositing the adhesion promoter on the first major surface 18 that exhibits a water contact angle (after deposition) that is greater than or equal to 40° and less than or equal to 65° (e.g., greater than or equal to 45° and less than or equal to 60°, greater than or equal to 48° and less than or equal to 52°) provides suitable amounts of feature rounding (e.g., in terms of transition width of the features and AF curve with a suitably sloped intermediate portion).

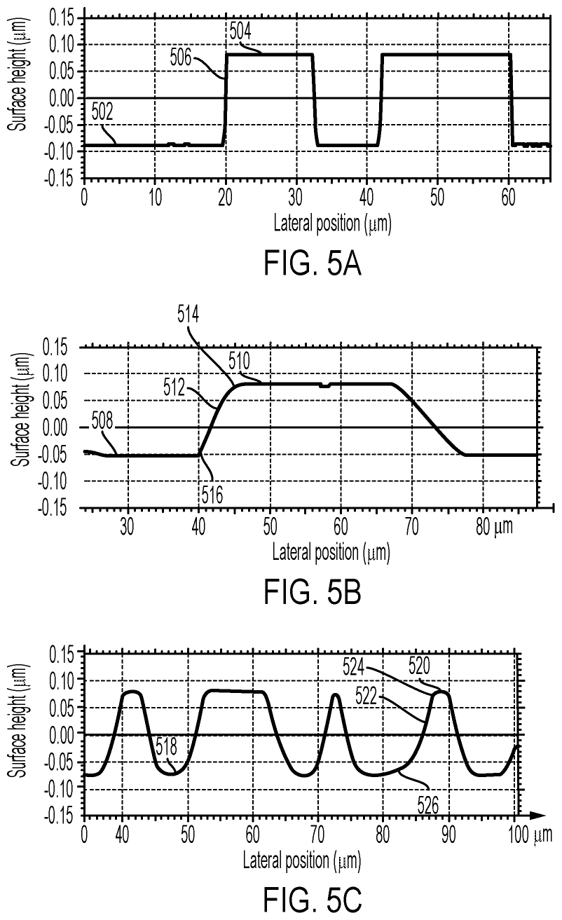

It is believed that the secondary etching step described herein provides surface structures having a different shape than those provided through the alternative method of adhesion control during the primary etching step. FIGS. 5A, 5B, 5C depict 2D surface height profiles (i.e., line profiles generated from white light interferometry data, representing cross-sections through the substrate 12 taken in a direction perpendicular to the base plane 30) for various samples. FIG. 5A is a sample after undergoing the primary etching step described herein with strong adhesion between the substrate and resist (the substrate exhibited a water contact angle above 70° prior to masking). FIG. 5B is a sample after undergoing the primary etching step where the adhesion promoter chemistry is modified to reduce adhesion between the substrate and the resist to promote undercutting (the substrate exhibited a water contact angle of less than 65° after the adhesion promoter was deposited). FIG. 5C is a sample after undergoing both the primary and secondary etching steps described herein with respect to FIG. 4. In the example shown in FIG. 5A, the represented surface includes first regions 502 defining a base plane, a second regions 504 disposed at a peak height that is at a height just less than 200 nm relative to the base plane. Transition surfaces 506 separate the first and second regions 502 and 504. As shown, the transition surfaces 506 define a transition width w (see FIG. 3B) that is less than 1 μm. Moreover, the features defined have relatively sharp corners. In the example shown in FIG. 5B, the represented surface includes first regions 508 defining a base plane and a plurality of second regions 510 disposed at a peak height that is at a height just less than 150 nm relative to the base plane. Transition surfaces 512 separate the first and second regions 508 and 510. However, in contrast with the sample shown in FIG. 5A, the transitions surfaces 512 define a transition width w that is greater than 1 μm. Moreover, convex corners 514 are rounded, indicating a degree of undercutting. Concave corners 516, however, are relatively unaffected by the undercutting and so the surface still abruptly changes in slope at the concave corners 516.

In the example shown in FIG. 5C, the represented surface includes first regions 518 defining a base plane, a plurality of second regions 520 disposed at a peak height that is at a height between 150 nm and 200 nm relative to the base plane. Transition surfaces 522 separate the first and second regions 518 and 520. The transitions surfaces 522 define a transition width w that is greater than 1 μm. In contrast to the example shown in FIG. 5B, however, both convex corners 524 and concave corners 526 are rounded, such that there are less abrupt transitions in surface slope in the example shown in FIG. 5C than in the example shown in FIG. 5B. It is believed that such removal of high spatial frequency features is associated with reduced scattering amplitudes at high scattering angles (i.e., superior washout performance). Moreover, as described in greater detail, such gradual surface transitions are believed to be associated with superior abrasion performance.

### Substrate Properties

Various properties of the substrate 12 will now be described, according to embodiments of the present disclosure.

In embodiments, the substrate 12 is a glass substrate or a glass-ceramic substrate. In embodiments, the substrate 12 is a multi-component glass composition having about 40 mol % to 80 mol % silica and a balance of one or more other constituents, e.g., alumina, calcium oxide, sodium oxide, boron oxide, etc. In some implementations, the bulk composition of the substrate 12 is selected from the group consisting of aluminosilicate glass, a borosilicate glass, and a phosphosilicate glass. In other implementations, the bulk composition of the substrate 12 is selected from the group consisting of aluminosilicate glass, a borosilicate glass, a phosphosilicate glass, a soda lime glass, an alkali aluminosilicate glass, and an alkali aluminoborosilicate glass. In further implementations, the substrate 12 is a glass-based substrate, including, but not limited to, glass-ceramic materials that comprise a glass component at about 90% or greater by weight and a ceramic component. In other implementations of the article 10, the substrate 12 can be a polymer material, with durability and mechanical properties suitable for the development and retention of the scattering region 20.

In embodiments, the substrate 12 has a bulk composition that comprises an alkali aluminosilicate glass that comprises alumina, at least one alkali metal and, in some embodiments, greater than 50 mol % SiO₂, in other embodiments, at least 58 mol % SiO₂, and in still other embodiments, at least 60 mol % SiO₂, wherein the ratio (Al₂O₃ (mol %)+B₂O₃ (mol %))/Σ alkali metal modifiers (mol %)>1, where the modifiers are alkali metal oxides. This glass, in particular embodiments, comprises, consists essentially of, or consists of: about 58 mol % to about 72 mol % SiO₂; about 9 mol % to about 17 mol % Al₂O₃; about 2 mol % to about 12 mol % B₂O₃; about 8 mol % to about 16 mol % Na₂O; and 0 mol % to about 4 mol % K₂O, wherein the ratio (Al₂O₃ (mol %)+B₂O₃ (mol %))/Σ alkali metal modifiers (mol %)>1, where the modifiers are alkali metal oxides.

In embodiments, the substrate 12 has a bulk composition that comprises an alkali aluminosilicate glass comprising, consisting essentially of, or consisting of: about 61 mol % to about 75 mol % SiO₂; about 7 mol % to about 15 mol % Al₂O₃; 0 mol % to about 12 mol % B₂O₃; about 9 mol % to about 21 mol % Na₂O; 0 mol % to about 4 mol % K₂O; 0 mol % to about 7 mol % MgO; and 0 mol % to about 3 mol % CaO.

In embodiments, the substrate 12 has a bulk composition that comprises an alkali aluminosilicate glass comprising, consisting essentially of, or consisting of: about 60 mol % to about 70 mol % SiO₂; about 6 mol % to about 14 mol % Al₂O₃; 0 mol % to about 15 mol % B₂O₃; 0 mol % to about 15 mol % Li₂O; 0 mol % to about 20 mol % Na₂O; 0 mol % to about 10 mol % K₂O; 0 mol % to about 8 mol % MgO; 0 mol % to about 10 mol % CaO; 0 mol % to about 5 mol % ZrO₂; 0 mol % to about 1 mol % SnO₂; 0 mol % to about 1 mol % CeO₂; less than about 50 ppm As₂O₃; and less than about 50 ppm Sb₂O₃; wherein 12 mol %≤Li₂O+Na₂O+K₂O≤20 mol % and 0 mol %≤MgO+Ca≤10 mol %.

In embodiments, the substrate 12 has a bulk composition that comprises an alkali aluminosilicate glass comprising, consisting essentially of, or consisting of: about 64 mol % to about 68 mol % SiO₂; about 12 mol % to about 16 mol % Na₂O; about 8 mol % to about 12 mol % Al₂O₃; 0 mol % to about 3 mol % B₂O₃; about 2 mol % to about 5 mol % K₂O; about 4 mol % to about 6 mol % MgO; and 0 mol % to about 5 mol % CaO, wherein: 66 mol %≤SiO₂+B₂O₃+CaO≤69 mol %; Na₂O+K₂O+B₂O₃+MgO+CaO+SrO>10 mol %; 5 mol %≤MgO+CaO+SrO≤8 mol %; (Na₂O+B₂O₃)—Al₂O₃≤2 mol %; 2 mol %≤Na₂O—Al₂O₃≤6 mol %; and 4 mol %≤(Na₂O+K₂O)—Al₂O₃≤10 mol %.

In embodiments, the substrate 12 has a bulk composition that comprises SiO₂, Al₂O₃, P₂O₅, and at least one alkali metal oxide (R₂O), wherein 0.75>[(P₂O₅ (mol %)+R₂O (mol %))/M₂O₃ (mol %)]≤1.2, where M₂O₃=Al₂O₃+B₂O₃. In embodiments, [(P₂O₅ (mol %)+R₂O (mol %))/M₂O₃ (mol %)]=1 and, in embodiments, the glass does not include B₂O₃ and M₂O₃=Al₂O₃. The substrate 12 comprises, in embodiments: about 40 to about 70 mol % SiO₂; 0 to about 28 mol % B₂O₃; about 0 to about 28 mol % Al₂O₃; about 1 to about 14 mol % P₂O₅; and about 12 to about 16 mol % R₂O. In some embodiments, the glass substrate comprises: about 40 to about 64 mol % SiO₂; 0 to about 8 mol % B₂O₃; about 16 to about 28 mol % Al₂O₃; about 2 to about 12 mol % P₂O₅; and about 12 to about 16 mol % R₂O. The substrate 12 may further comprise at least one alkaline earth metal oxide such as, but not limited to, MgO or CaO.

In some embodiments, the substrate 12 has a bulk composition that is substantially free of lithium; i.e., the glass comprises less than 1 mol % Li₂O and, in other embodiments, less than 0.1 mol % Li₂O and, in other embodiments, 0.01 mol % Li₂O, and in still other embodiments, 0 mol % Li₂O. In some embodiments, such glasses are free of at least one of arsenic, antimony, and barium; i.e., the glass comprises less than 1 mol % and, in other embodiments, less than 0.1 mol %, and in still other embodiments, 0 mol % of As₂O₃, Sb₂O₃, and/or BaO.

In embodiments, the substrate 12 has a bulk composition that comprises, consists essentially of or consists of a glass composition, such as Corning® Eagle XG® glass, Corning® Gorilla® glass, Corning Gorilla Glass 2, Corning Gorilla Glass 3, Corning® Gorilla® Glass 4, or Corning® Gorilla Glass 5.

In embodiments, the substrate 12 has an ion-exchangeable glass composition that is strengthened by either chemical or thermal means that are known in the art. In embodiments, the substrate 12 is chemically strengthened by ion exchange. In that process, metal ions at or near the first major surface 18 of the substrate 12 are exchanged for larger metal ions having the same valence as the metal ions in the glass substrate. The exchange is generally carried out by contacting the substrate 12 with an ion exchange medium, such as, for example, a molten salt bath that contains the larger metal ion. The metal ions are typically monovalent metal ions, such as, for example, alkali metal ions. In one non-limiting example, chemical strengthening of a substrate 12 that contains sodium ions by ion exchange is accomplished by immersing the substrate 12 in an ion exchange bath comprising a molten potassium salt, such as potassium nitrate (KNO₃) or the like. In one particular embodiment, the ions in the surface layer of the substrate 12 contiguous with the first major surface 18 and the larger ions are monovalent alkali metal cations, such as Li⁺ (when present in the glass), Na⁺, K⁺, Rb⁺, and Cs⁺. Alternatively, monovalent cations in the surface layer of the substrate 12 may be replaced with monovalent cations other than alkali metal cations, such as Ag⁺ or the like.

In such embodiments, the replacement of small metal ions by larger metal ions in the ion exchange process creates a compressive stress region in the substrate 12 that extends from the first major surface 18 to a depth (referred to as the “depth of layer”) that is under compressive stress. This compressive stress of the substrate 12 is balanced by a tensile stress (also referred to as “central tension”) within the interior of the substrate 12. In some embodiments, the first major surface 18 of the substrate 12 described herein, when strengthened by ion exchange, has a compressive stress of at least 350 MPa, and the region under compressive stress extends to a depth, i.e., depth of layer, of at least 15 μm below the first major surface 18 into the thickness 21.

Ion exchange processes are typically carried out by immersing the substrate 12 in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass as a result of the strengthening operation. By way of example, ion exchange of alkali metal-containing glasses may be achieved by immersion in at least one molten bath containing a salt, such as, but not limited to, nitrates, sulfates, and chlorides, of the larger alkali metal ion. The temperature of the molten salt bath typically is in a range from about 380 °C up to about 450 °C, while immersion times range from about 15 minutes up to about 16 hours. However, temperatures and immersion times different from those described above may also be used. Such ion exchange treatments, when employed with a substrate 12 having an alkali aluminosilicate glass composition, result in a compressive stress region having a depth (depth of layer) ranging from about 10 μm up to at least 50 μm, with a compressive stress ranging from about 200 MPa up to about 800 MPa, and a central tension of less than about 100 MPa.

As the etching processes that can be employed to create the scattering region 20 of the substrate 12 can remove alkali metal ions from the substrate 12 that would otherwise be replaced by a larger alkali metal ion during an ion exchange process, a preference exists for developing the compressive stress region in the article 10 after the formation and development of the scattering region 20.

### EXAMPLES

Embodiments of the present disclosure may be further understood in view of the following examples.

### Examples 1-5

Examples 1-5 were fabricated by forming the plurality of structures 26 in the primary etching step by varying the degree of adhesion between the resist and the substrate 12. Particularly, an adhesion promoter (HMDS) was deposited on the substrate 12. However, the water contact angle of the first major surface 18 varied after disposal of the adhesion promoter to vary the strength of adhesion to a photoresist (Megaposit™ SPR220, MicroChemicals AZ1500). The water contact angle was varied by exposing the HMDS layer to tetra methyl ammonia hydroxide for various exposure times to vary the silane concentration of the promoter. The water contact angle of the first major surface 18 was varied from 76° (strong adhesion and minimal undercutting) to 50° (relatively weak adhesion and large amounts of undercutting). After a pattern is determined for the plurality of structures 26 via the methods described herein, the photoresist was exposed to light based on the pattern to facilitate formations of opening in the resist and etching the substrate 12 form the base plane 30. Positive or negative resists can be used to achieve similar results. In Example 1, the substrate 12 exhibited a water contact angle of about 76° prior to application of the adhesion promoter. In Example 2, the substrate 12 exhibited a water contact angle of about 71°. In Example 3, the substrate 12 exhibited a water contact angle of about 68°. In Example 4, the substrate 12 exhibited a water contact angle of about 61°. In Example 5, the substrate 12 exhibited a water contact angle of about 50°. The photoresists were cured for the same pattern for each of Examples 1-5.

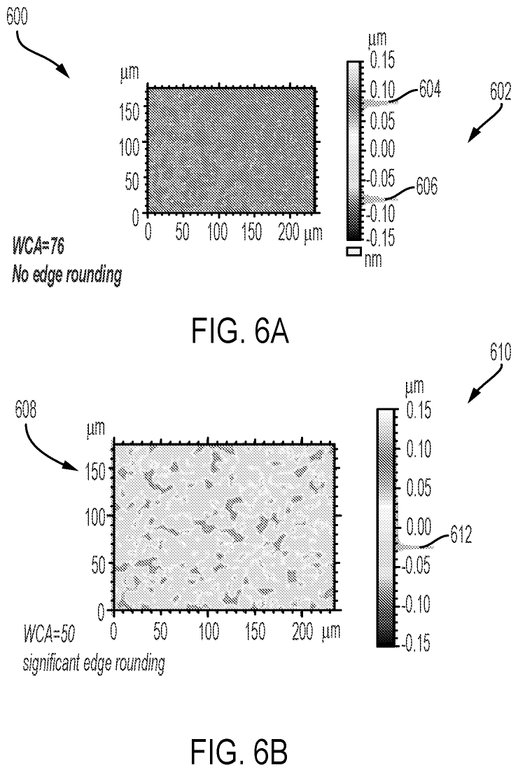

FIG. 6A is a 2D surface height profile 600 measured from the scattering region 20 of Example 1. The 2D surface height profile represents a portion of a 1×1 mm² area of the scattering region 20 being measured with a white light interferometer with a 360 nm lateral resolution per pixel. Each pixel in the measurement represents a surface height. From the 2D surface height profile 600, a histogram 602 of height occurrences is generated. The histogram 602 includes a first peak 604 representing unetched portions of the scattering region 20 during the primary etching step and a second peak 606 representing fully etched areas (establishing the base plane 30). The counts for surface heights outside of the first and second peaks 604 and 606 are very low, indicating minimal slope of the transition surfaces between the plateaus at the heights associated with the first and second peaks 604 and 606. FIG. 6B depicts a 2D surface height profile 608 measured from the scattering region 20 of Example 5 (with a high amount of feature rounding). As shown, the histogram 610 only includes a single peak 612, representing fully etched areas (establishing the base plane 30). The high degree of feature rounding in this example eliminated an upper peak associated with a single peak height. However, as shown in the histogram 610, the occurrences for heights above the height associated with the single peak 612 are higher than in the areas outside the first and second peaks 604 and 606 associated with Example 1. This indicates a gradual slope of the scattering region 20 and a lack of vertical transition surfaces.

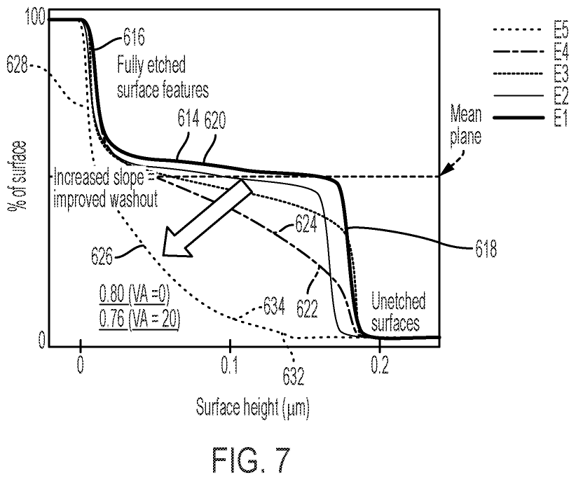

AF curves were used to characterize each of Examples 1-5. The AF curves were generated by integrating the surface height histograms (exemplified by the histograms 602 and 610 depicted in FIGS. 6A and 6B, respectively) to generate a surface area percentage occupied by each height. FIG. 7 is a plot including the AF curves for each of the examples. As shown, the AF curve 614 for the Example 1 includes a first portion 616, representing an area of the scattering region 20 that is disposed more proximate to the base plane 30 (regions of the first major surface 18 where most material was removed during the primary etching step), a second portion 618 representing peak portions (e.g., unetched portions or least etched portions, where the least amount of material of the substrate 12 was removed during the primary etching step), and an intermediate portion 620 extending between the first portion 616 and the second portion 618. For the Example 1, the first and second portions 616 and 618 represent the percentage of the first major surface 18 that are disposed at the heights associated within the first and second peaks 604 and 606 depicted in FIG. 6. The first and second portions 616 and 618 are vertical portions of the AF curve for Example 1, having relatively high or undefined slopes. In the depicted embodiment, the first and second portions 616 and 618 have slopes that are greater than 420%/μm.

As described herein, the boundaries of various “portions” of AF curves described herein (e.g., first portion, second portion, and intermediate portion) can be identified by locating segments of the AF curves where the slope abruptly changes. A portion boundary can be characterized as an AF curve segment where the slope transitions by at least 5%/μm over a segment representing 100 nm of surface heights or as an inflection point of the AF curves. Inflection points themselves can represent intermediate portions described herein.

As shown in FIG. 7, the degree of feature rounding imparted by reducing adhesion of the photoresist during the primary etching steps in the Examples 1-5 altered the shape of the AF curves. For examples 1-5, the second portions of the AF curves (representing the peak portions 42 of the plurality of structures 26) get shorter in length, indicating that a smaller percentage of the first major surface 18 is disposed at a height corresponding to the etch depth in the primary etching step relative to the base plane 30. Moreover, the intermediate portions (representing the sloped portions 40 of the plurality of structures 26) of the AF curves get larger slopes with greater degrees of feature rounding. To illustrate, in the AF curve 614 associated with the Example 1, the slope of the intermediate portion 620 is about 0.6%/μm. An AF curve 622 associated with the Example 4, in contrast, includes an intermediate portion 624 having a slope of about 238.9%/μm. The larger slopes of the intermediate portions generally indicates that the sloped portions 40 of the plurality of structures 26 take a larger area fraction of the first major surface 18 in the scattering region 20 (projected into the base plane 30). The AF curve 622 representing Example 4 has an intermediate portion 624 representing approximately 35% of the scattering region 20. This can be determined based on a projection of the intermediate portion on the vertical axis of the AF curve. Applicant has found that, when the sloped portions 40 of the plurality of structures 26 take up more than 5% of a total surface area of the scattering region 20, and the intermediate portion of the AF curve has a slope that is greater than or equal to 5%/μm and less than 420%/μm (e.g., greater than or equal to 10%/μm and less than or equal to 200%/μm, greater than or equal to 20% and less than or equal to 150%/μm), the degree of feature rounding is sufficient to provide the superior washout performance described herein.

As shown in FIG. 7, the AF curve 626 associated with Example 5 includes a first portion 628, which is a substantially vertical portion represented the maximally etched portions of the first major surface 18, a second portion 632, representing peak portions 42 of the plurality of structures 26, and an intermediate portion 634. The second portion 632 differs in shape from those of Examples 1~4 due to the high degree of feature rounding. Since there are no plateaus at the peak heights and features are completely rounded, the second portion 632 is relatively small segment at the highest height where the AF curve 626 transitions from zero to finite slope. The intermediate portion 634 has a relatively high slope (about 375%/μm) as a result of the high degree of feature rounding.

A “washout” metric has been formulated to quantify the effects of glare events (e.g., exposure to sunlight) on the contrast and resolution of an incorporating display. Such a metric is useful to examine cover material performance for applications likely to be exposed to light from external light sources (e.g., automotive interior displays, outdoor displays). To quantify “washout,” a modulation transfer function (MTF) of an anti-glare surface is measured under various illumination conditions, and the average value of the MTF over a number of spatial frequencies is used to evaluate the effect of illumination conditions on display performance. The MTF at a particular spatial frequency f may be expressed as

$$M T F ( f ) = \frac{M {F}_{o u t} ( f )}{M {F}_{i n ( f )}} \qquad ( 8 )$$

where

$$M {F}_{i} ( f ) = \frac{{{I}_{i} ( f )}_{max} - {{I}_{i} ( f )}_{min}}{{{I}_{i} ( f )}_{max} + {{I}_{i} ( f )}_{min}} , \qquad ( 9 )$$

and I(f)ₘₐₓ and I(f)ₘᵢₙ are the maximum and minimum intensities of an input or an output modulation image at the spatial frequency f. In this expression, MFᵢₙ represents the MF value associated with an input pattern being emitted through a sample cover material. The MFₒᵤₜ value represents the MF value when the cover material is disposed over the input pattern (e.g., from a display) and under the illumination condition being tested. Higher MTF values generally mean that the illumination condition has less of an effect on display performance (and therefore better performance of the scattering region of the cover material). In embodiments, MTF values of greater than or equal to 0.60 (e.g., greater than or equal to 0.65, greater than or equal to 0.70, greater than or equal to 0.75 greater than or equal to 0.76, greater than or equal to 0.77, greater than or equal to 0.78, greater than or equal to 0.79, greater than or equal to 0.80, greater than or equal to 0.81, greater than or equal to 0.82, greater than or equal to 0.83, greater than or equal to 0.84, greater than or equal to 0.85, greater than or equal to 0.86, greater than or equal to 0.87, greater than or equal to 0.88, greater than or equal to 0.89, greater than or equal to 0.90, greater than or equal to 0.91, greater than or equal to 0.92, greater than or equal to 0.93, greater than or equal to 0.94, and greater than or equal to 0.95) are preferred for a given illumination condition, indicating minimal degradation of display performance caused by exposure to the external light.

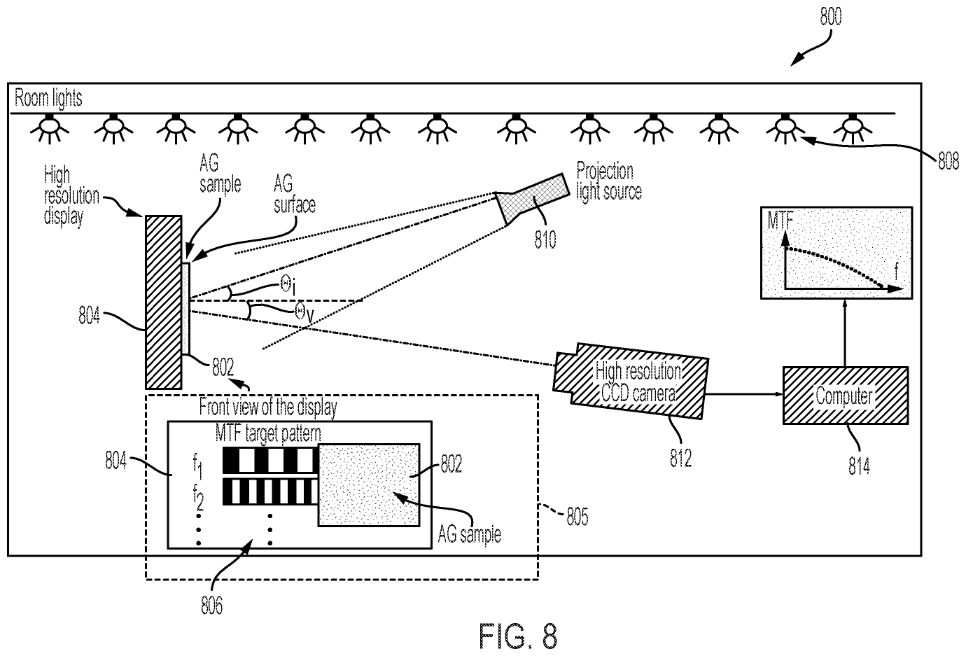

FIG. 8 schematically depicts an apparatus 800 for measuring the washout effect. As shown, a sample 802 (e.g., corresponding to the substrate 12 described herein) is placed over a display 804. The sample 802 is positioned so that the scattering region faces outward (not towards the display 804). As shown in the box 805 (which depicts a front view of the sample 802 and the display 804), the display 804 generates a plurality of target patterns 806 where the intensity of light emitted by the display 804 varies with a particular spatial frequency fᵢ. A plurality of first light sources 808 are distributed around the sample 802. The plurality of first light sources 808 (e.g., room lights) are configured to emit a relatively low intensity light to simulate the sample 802 encountering normal ambient conditions (e.g., room light). As reported herein, the plurality of first light sources 808 were configured to emit white light with 130 lux and a color temperature of 2100k). A projection light source 810 is configured to emit a relatively high intensity light source to simulate sunlight illumination. The projection light source 810 is positioned such that light emitted thereby is incident on the sample with an angle of incidence Θᵢ. In embodiments, the projection light source 810 is movable or otherwise adjustable so as to change the angle of incidence Θᵢ. In embodiments, the projection light source 810 emits light over an emission area, such that light emitted by the projection light source 810 is incident on the sample 802 at a range of angles of incidence Θᵢ.

A camera 812 is positioned to receive light scattered from the sample 802. The camera is positioned such that light scattered from the sample 802 will enter the camera 812 at a viewing angle Θᵥ (or range of viewing angles). In embodiments, the camera 812 is movable or otherwise adjustable to change the viewing angle Θᵥ. A computing system 814 receives an image generated by the camera 812 and analyzes the image to compute a plurality of MTF values for each of the plurality of target patterns 806 emitted by the display 804. For each of the target patterns 806, the computing system 814 may calculate an MTF value using Equations 8 and 9 and generate an output that measures the dependency of the MTF value on spatial frequency. The plurality of first light sources 808 and the projection light source 810 allow the MTF values to be measured under a plurality of different lighting conditions to determine the efficacy of the pattern on the sample 802 in reducing washout. When just the first light sources 808 are emitting light, a “room light washout” effect can be measured. When both the first light sources 808 and the projection light source 810 are emitting light, a “sunlight washout” effect can be measured.

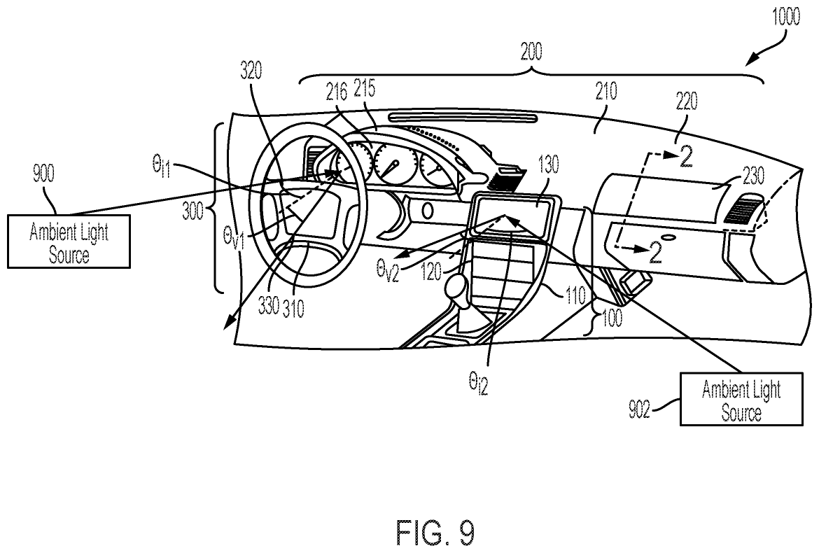

Such washout measurements may be particularly useful in evaluating the performance of cover materials for automotive interior displays. FIG. 9 shows a vehicle interior 1000 that includes three different vehicle interior systems 100, 200, 300, according to an exemplary embodiment. Vehicle interior system 1000 includes a center console base 110 with a surface 120 including a display 130. Vehicle interior system 200 includes a dashboard base 210 with a surface 220 including a display 230. The dashboard base 210 typically includes an instrument panel 215 which may also include display 216. Vehicle interior system 300 includes a dashboard steering wheelbase 310 with a surface 320 and a display 330. In one or more embodiments, the vehicle interior system may include a base that is an arm rest, a pillar, a seat back, a floorboard, a headrest, a door panel, or any portion of the interior of a vehicle that includes a surface. In embodiments, the displays 130, 230, 330 are flat and comprise cover glass with planar major surfaces. In embodiments, one or more of the displays 130, 230, 330 are curved, and the curved display may include curved cover glass that may be hot-formed or cold-formed to possess such curvature. For example, such embodiments may incorporate opaque layers formed of the photocurable inks described herein disposed on cold-formed glass substrates. Such cold-forming may involve any of the techniques described in U.S. Pre-Grant Publication No. 2019/0329531 A1, entitled “Laminating thin strengthened glass to curved molded plastic surface for decorative and display cover application,” U.S. Pre-Grant Publication No. 2019/0315648 A1, entitled “Cold-formed glass article and assembly process thereof,” U.S. Pre-Grant Publication No. 2019/0012033 A1, entitled “Vehicle interior systems having a curved cover glass and a display or touch panel and methods for forming the same,” and U.S. patent application Ser. No. 17/214,124, entitled “Curved glass constructions and methods for forming same,” which are hereby incorporated by reference in their entireties.

Various components of the vehicle interior 1000 may be subjected to illumination from various light sources. As depicted in FIG. 9, for example, a first ambient light source 900 may emit light that is transmitted through a first side window of the vehicle and incident on the display 216 with at an angle of incidence Θᵢ₁. The display 216 may be oriented such that light scattered at a particular scattering angle Θᵥ₁ will enter the driver's field of vision and distract the driver. A second ambient light source 902 may emit that is transmitted through a second side window of the vehicle and incident on the display 130 with at an angle of incidence Θᵢ₂. The display 130 may be oriented such that light scattered at a particular scattering angle Θᵥ₂ will enter the driver's field of vision and distract the driver. The first and second ambient light sources 900 and 902 may represent sunlight at various points in time. Indeed, the ISO 15002/SA 1757 standards specify a first condition where 45k lux light (direct sunlight) is incident on the display 216 at an angle of 20° and scatters into the driver at a scattering angle of 0° (i.e., where Θᵢ₁=20° and Θᵥ₁=0°, associated with the “washout₁” metric herein) and a second condition where 45k lux light (direct sunlight) is incident on the display 130 at an angle of 45° and scatters into the driver at a scattering angle of 20° (i.e., where Θᵢ₂=45° and Θᵥ₂=20°, associated with the “washout₂” metric herein). The apparatus 800 depicted in FIG. 8 enables such conditions to be tested for washout by varying the orientation of the sample 802 and adjusting the projection light source 810.

Using the apparatus 800 depicted in FIG. 8, the two conditions of ISO 15002/SA 1757 described herein were used to test Examples 1-5. An Apple® mini-iPad® 4 was used as the display 804. A Pixelink 3.1 MP PL-B776 was used as the camera 812. A collimated LED light source (emitting 45000 lux white light) was used at the projection light source 810 (made by Mightex Systems, model of LCS-6500-65-22). Multiple projection light sources were used and positioned so as to emit light incident on the sample 802 at angles of incidence of 20° and 45°. The sample 802 and camera 812 were also mounted on a rotation stage so as to render the viewing angle Θᵥ and angle of incidence Θᵢ adjustable for the two conditions. Lab room light was used as the first light sources 808 and was measured to have a luminance of 132 lux.

To quantitatively evaluate the impact of the sample 802, the MTF values at the spatial frequencies of 1.67 cycles/mm, 4.11 cycles/mm, 7.33 cycles/mm, 10.38 cycles/mm, and 13.08 cycles/mm were averaged for each of the series. The “washout” metrics described herein were an average of the MTF values over these spatial frequencies for each condition.

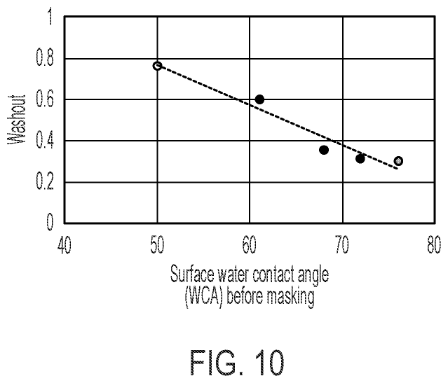

FIG. 10 is a plot of the Washout₂ metric described herein with respect to FIGS. 8 and 9 as a function of water contact angle of the substrate after disposal (and modification) of the adhesion promoter. As shown, the washout₂ metric is generally below 0.5 for water contact angles above 65°. However, when the photoresist exhibits a water contact angle of below 65 °C. The washout₂ metric is above 0.6 and above, indicating more favorable washout performance. These results demonstrate that higher degrees of feature rounding, and therefore surfaces characterized by AF curves having the characteristics described herein, are associated with better washout performance.

### Examples 6-11

In Examples 6-11, Corning Gorilla® Glass 5 was used as the substrate. To perform the primary etching an adhesion layer (HMDS) was applied to the first major surface. A photoresist at <2 μm thickness (Megaposit™ SPR220, MicroChemicals AZ1500) was then applied on the adhesion layer, and subsequently exposed to UV light. Positive toning was used, so that the areas exposed to UV were removed by alkaline developer (<1% TMAH tetramethylammonium hydroxide or 0.24 wt % potassium hydroxide or 1 wt % sodium carbonate Na₂CO₃), while unexposed areas were not affected by the developer. Finally, wet etching (dip/spray) was used to transfer the patterned features onto the glass. The primary etchant was hydrofluoric acid (e.g. HF/HNO₃ or HF/HCl) at room temperature. Typically, unmasked side was laminated with an acid etch resistant film to prevent etching. The primary etching step was used to form the same pattern in each of Examples 6-11.

For Examples 6-11, the secondary etching step was performed with the glass loaded in the vertical orientation and the secondary etchant being sprayed onto the top of the glass, so that the etchant flows across the surface from the top of the sample to the bottom of the sample, under the influence of gravity. Concentrations of the secondary etching solution were varied from 16 mM HF/20 mM HCl to 160 mM HF/200 mM HCl to reach the etch rate from 0.1 to 1 μm/min. Etching times were varied from 5 minutes to 20 minutes. Examples 6 and 7 utilized an etching rate of 1 μm/minute. Examples 8 and 9 utilized an etching rate of 0.02 μm per min. Examples 10 and 11 utilized an etching rate of 0.1 μm/min. Optical properties of the samples were measured both before and after secondary etching. The results are provided in the Table 1 below. 3 samples at each etching configuration were measured.

TABLE 1

| | | | Before spray-polishing | | | | | | | |
|---|---|---|---|---|---|---|---|---|---|---|
| | Etch | | Uncoupled | Uncoupled | Uncoupled | Coupled | Coupled | Coupled | | |
| E# | Time | | Gloss60 | DOI | Rspec | Gloss60 | DOI | Rspec | Trans | Haze |
| 6A | 5 | min | 121.3 | 94.9 | 60.8 | 64.9 | 43.4 | 6.2 | 93.1 | 3.34 |
| 6B | 5 | min | 120.8 | 94.8 | 60.2 | 65.4 | 48.3 | 6.6 | 93 | 3.35 |
| 6C | 5 | min | 119.6 | 95 | 60.1 | 65.4 | 46.2 | 6.5 | 93 | 3.39 |
| 7A | 20 | min | 119.1 | 94.8 | 59.7 | 65.2 | 50.9 | 6.8 | 93.1 | 3.44 |
| 7B | 20 | min | 121.8 | 94.7 | 60.7 | 63.9 | 54.1 | 6.8 | 93 | 3.35 |
| 7C | 20 | min | 121.6 | 94.8 | 60.9 | 64.6 | 50.3 | 6.5 | 93 | 3.34 |
| 8A | 5 | min | 120 | 94.9 | 60.7 | 65.1 | 52.5 | 6.8 | 93 | 3.47 |
| 8B | 5 | min | 120.4 | 94.9 | 60.5 | 65.1 | 51.5 | 6.7 | 93 | 3.48 |
| 8C | 5 | min | 120.1 | 94.9 | 61.1 | 65 | 51.2 | 6.7 | 93 | 3.44 |
| 9A | 20 | min | 121.2 | 94.9 | 61.7 | 66 | 47 | 6.5 | 93 | 3.25 |
| 9B | 20 | min | 123 | 95 | 62.4 | 65.7 | 47.2 | 6.5 | 93.1 | 3.22 |
| 9C | 20 | min | 122.7 | 95.1 | 62.7 | 65.4 | 45.7 | 6.3 | 93 | 3.24 |
| 10A | 5 | min | 120.8 | 94.9 | 61.4 | 66.1 | 46.7 | 6.5 | 93 | 3.23 |
| 10B | 5 | min | 122.7 | 95.1 | 62.6 | 66.5 | 46.6 | 6.6 | 93.1 | 3.19 |
| 10C | 5 | min | 123.1 | 95 | 62.6 | 65.7 | 46.8 | 6.5 | 93.1 | 3.22 |
| 11A | 20 | min | 122.4 | 94.9 | 61.7 | 67 | 47.5 | 6.8 | 93 | 3.14 |
| 11B | 20 | min | 122.9 | 95.1 | 62.8 | 66.9 | 45.6 | 6.7 | 93.1 | 3.21 |
| 11C | 20 | min | 122.9 | 95.1 | 61.9 | 67.4 | 44 | 6.6 | 93 | 3.2 |

| | After spray-polishing | | | | | | | |
|---|---|---|---|---|---|---|---|---|
| | Uncoupled | Uncoupled | Uncoupled | Coupled | Coupled | Coupled | | |
| E# | Gloss60 | DOI | Rspec | Gloss60 | DOI | Rspec | Trans | Haze |
| 6A | 121.9 | 95 | 60.4 | 66.2 | 51.6 | 6.7 | 93.1 | 2.71 |
| 6B | 123.3 | 94.8 | 60.2 | 67.1 | 48.5 | 6.6 | 93.2 | 2.81 |
| 6C | 122.6 | 94.9 | 60.7 | 64.2 | 65.9 | 7.9 | 93.2 | 2.69 |
| 7A | 126.4 | 95.6 | 65.4 | 67.6 | 78.8 | 12.6 | 93.2 | 1.86 |
| 7B | 128.8 | 95.4 | 66.5 | 70.3 | 72.9 | 10.8 | 93.2 | 2 |
| 7C | 128.7 | 95.5 | 66.6 | 71 | 74.8 | 11.4 | 93.2 | 1.96 |
| 8A | 118.7 | 94.8 | 58.8 | 64.9 | 51.2 | 6.7 | 93.1 | 3.44 |
| 8B | 120 | 94.8 | 58.7 | 65 | 51.5 | 6.6 | 93.1 | 3.33 |
| 8C | 118.8 | 94.7 | 58.8 | 64.7 | 51.2 | 6.6 | 93.1 | 3.39 |
| 9A | 122.9 | 94.7 | 59.9 | 67.5 | 45.8 | 6.6 | 93.2 | 2.67 |
| 9B | 124.4 | 94.9 | 61.5 | 67.7 | 44.6 | 6.6 | 93.1 | 2.74 |
| 9C | 124.4 | 95 | 61.9 | 67.6 | 44 | 6.5 | 93.1 | 2.68 |
| 10A | 120.7 | 94.9 | 59.9 | 61.3 | 71.9 | 9.1 | 93.2 | 3.28 |
| 10B | 122.1 | 94.9 | 59.9 | 65.6 | 45.1 | 6.3 | 93.2 | 3.26 |
| 10C | 119.6 | 94.7 | 59 | 66.1 | 44.3 | 6.3 | 93.2 | 3.39 |
| 11A | 121.8 | 95 | 60 | 66.9 | 44.8 | 7.4 | 93.2 | 3.1 |
| 11B | 120.5 | 94.8 | 58.9 | 66.2 | 42.2 | 6.1 | 93.2 | 3.1 |
| 11C | 120.2 | 94.6 | 58.7 | 66.3 | 41.5 | 6.2 | 93.2 | 3.17 |

As shown, a systemic difference between the samples before and after the secondary spray etching step is that the samples exhibited a lower transmission haze after the secondary etching step. Transmission haze can therefore be used to monitor the secondary etching step described herein. Moreover, the samples subjected to secondary etching exhibited comparable specular reflectance, DOI, and gloss values to the unpolished samples. These results demonstrate that the feature rounding provided via the methods described herein can aid in improving washout performance without degrading other important AR performance attributes.

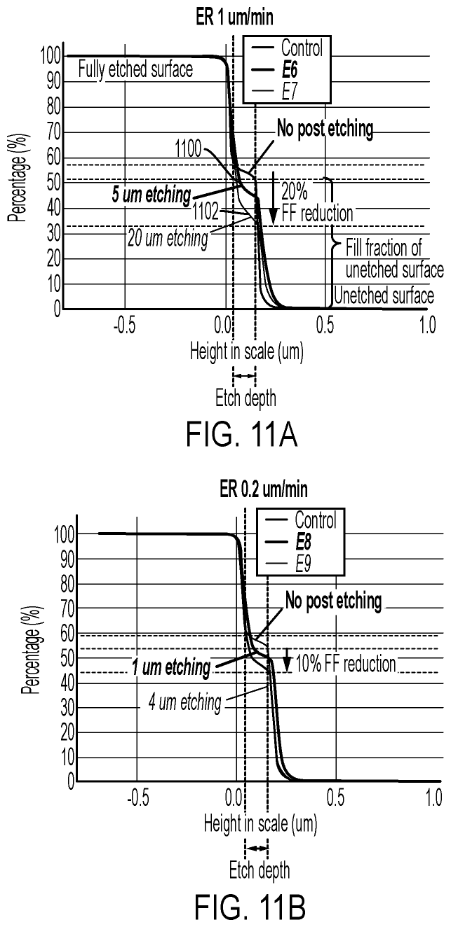

FIGS. 11A, 11B, and 11C are AF curves representing surfaces of Examples 6-11. These curves generally illustrate how the secondary etch step alters the profile of the first major surface 18. Each of FIGS. 11A, 11B, and 11C includes a control AF curve representing the sample prior to secondary etching. FIG. 11A represents Examples 6 and 7, which were formed using a 1 μm/min etch rate in the secondary etching step. As shown by the AF curve associated with Example 6, a 5 minute etching period reduced the fill fraction of the scattering region 20 taken up by portions of the first major surface 18 disposed at the etch depth of the primary etching step relative to the base plane by about 8%. The slope of the intermediate portion 1100 (between the vertical portions associated with the plateau heights) is also increased relative to the control. As illustrated by the AF curve associated with Example 7, increasing the etching time for the secondary etching step to 20 minutes results in a 20% reduction in fill fraction associated with portions of the first major surface 18 disposed at the etch depth of the primary etching step relative to the base plane. Moreover, the slope of the intermediate portion 1102 is further increased relative to the intermediate portion 1100 associated with the Example 6. FIGS. 11B and 11C demonstrate that lower etching rates of 0.1 μm/min and 0.2 μm/min can also be used to effectively provide feature rounding, with the same etching periods resulting in smaller filler fraction reductions for portions disposed at the etch depth of the primary etching step relative to the base plane.

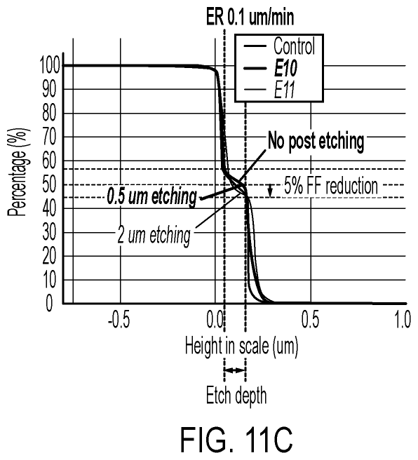

FIGS. 12A-12C are SEM images of cross-sections of samples used to measure the AF curves depicted in FIGS. 11A, 11B, and 11C. FIG. 12A is a SEM image of one of the Example 9 samples. FIG. 12B is a SEM image of one of the Example 10 samples. FIG. 12C is a SEM image of one of the Example 11 samples. A trend revealed by these images is that the total amount of the substrate etched out during the secondary etching step is proportional to the degree of feature rounding. No discernable sharp corner is observable in FIG. 12C, associated with 20 μm of total etching in the secondary etching step, whereas FIG. 12A, associated with 4 μm of total etching in the secondary etching step, still exhibits a relatively sharp top corner. Based on these results it is believed that the degree of rounding is not sensitive to the etching rate selected, but rather the total amount of etching that occurs in the secondary etching step. It is believed that slower etching rates (e.g., 0.1 μm/min) can be used for longer time periods (e.g., 200 minutes) to provide the same degree of feature rounding as faster etching rates (e.g., 1.0 μm/min) for shorter time periods (e.g., 20 minutes). However, faster etching rates may be preferrable for manufacturing efficiency.

### Examples 12-14

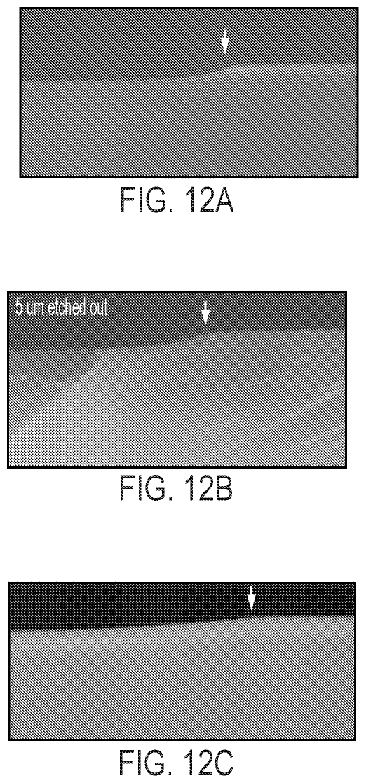

Examples 12-14 were formed by forming a pattern in the first major surface 18 of a substrate 12 (made of the same material as the Examples 6-11) via the methods described herein. Slightly different etch depths in the primary etching step was used to form each of these examples. FIG. 13A depicts a surface height profile 1300 of a control sample without any secondary etching. As shown, a corresponding histogram 1302 includes a first peak 1304 representing the base plane 30 and a second peak 1306 representing the peak portions 42 of the plurality of structures 26. The first and second peaks 1304 and 1306 are separated by an etch depth 1307 of about 132 nm. To fabricate Examples 12-14, samples were subjected to a dip etching step in a 1M HF/1M HCl solution to affect rounding of the features (the etch depths were slightly different for each of the samples). FIG. 13B is surface height profile 1310 for Example 12, which was exposed to 2 minutes of secondary etching. FIG. 13C is surface height profile 1320 for Example 13, which was exposed to 3 minutes of secondary etching. FIG. 13D is surface height profile 1330 for Example 14, which was exposed to 8 minutes of secondary etching. As is shown in the histograms 1312, 1322, and 1332, longer time periods of secondary etching generally results in a widening of the histogram peaks. For example, the histogram 1332 associated with Example 14 includes a first peak and second peaks 1334 and 1336 that are wider than the first and second peaks 1302 and 1306 associated with the control sample without secondary etching.

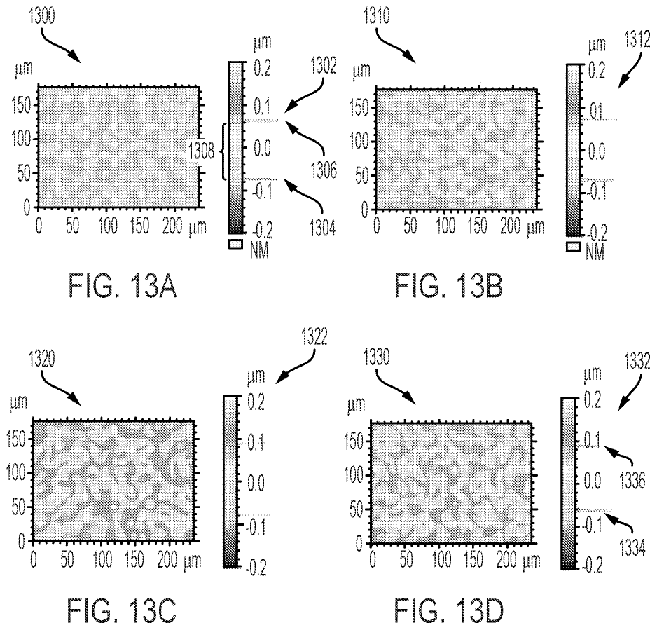

Examples 12-14 were further characterized by the AF curves shown in FIG. 14. A first AF curve 1400 is associated with the control sample represented by the surface height profile in FIG. 13A. As shown, the first AF curve 1400 includes a first portion 1402 representing regions of the first major surface that were etched in the primary etching step and a second portion 1404 representing portions of the first major surface that were not etched during the primary etching step. The first AF curve 1400 further includes an intermediate portion 1406 extending between the first portion 1402 and the second portion 1404. As a result of a lack of feature rounding, the intermediate portion 1406 has a relatively small slope of about 25%/μm when the etch depth is about 0.18 μm. A second AF curve 1408 represents Example 12. The second AF curve 1408 includes a first portion 1410, a second portion 1412, and an intermediate portion 1414. As shown, the intermediate portion 1414 has an average slope of about 83%/μm, which is large in comparison to the control sample as a result of the feature rounding imparted by a small amount of secondary etching. A third AF curve 1416 associated with Example 13 includes an intermediate portion 1418 having an average slope of about 100%/μm, still larger than the Example 12 as a result of the longer secondary etching step. A fourth AF curve 1420 associated with Example 14 includes an intermediate portion 1422 having an average slope of about 154%/μm, still larger than the Example 13 as a result of the longer secondary etching step. These examples demonstrate that the slope of the intermediate portion of an AF curve is generally proportional to the amount of material removed during the secondary etching step described herein, and can be controlled by selecting an appropriate etching rate and etching time period.

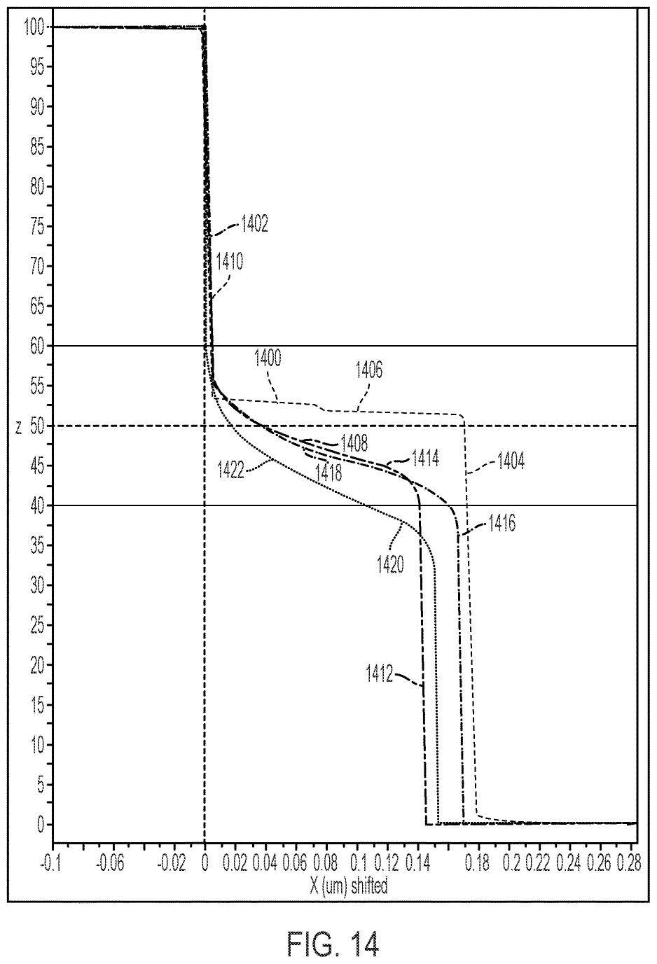

Bidirectional Reflection Distribution Function (BRDF) measurements were taken for Examples 12-14, as well as a comparative example manufactured using an existing non-mask based HF etching process (producing a randomized pattern). Measurements were taken in reflection mode using the REFLET 180S system from Synopsys, Inc. The measurement wavelength range (i.e., spectral range of light source of scattered light) was from 400 nm to 1700 nm with light at an incident angle of 10°. FIG. 15 is a plot of the scattering amplitude in (sr⁻¹) as a function of observation angle. As shown, the samples with feature rounding exhibited lower scattering intensities at scattering angles greater than or equal to 30° relative to specular. Indeed, at a 30° scattering angle, in terms of actual (non-normalized) BRDF amplitude, Examples 14 exhibited a BRDF amplitude of less than 1.2×10⁻⁴ sr⁻¹ at a 30° scattering angle, whereas the control exhibited a BRDF amplitude of 4×10⁻⁴ sr⁻¹. The differences are even greater at higher scattering angles. At a 40° scattering angle, in terms of actual (non-normalized) BRDF amplitude, Example 14 exhibited a BRDF amplitude of 5×10⁻⁵ sr⁻¹, whereas the control exhibited a BRDF amplitude of 1.7×10⁻⁴ sr⁻¹. Such relatively low BRDF amplitudes at high scattering angles achieved by the samples with feature rounding demonstrates the superior washout performance of such samples.

### Examples 15-17

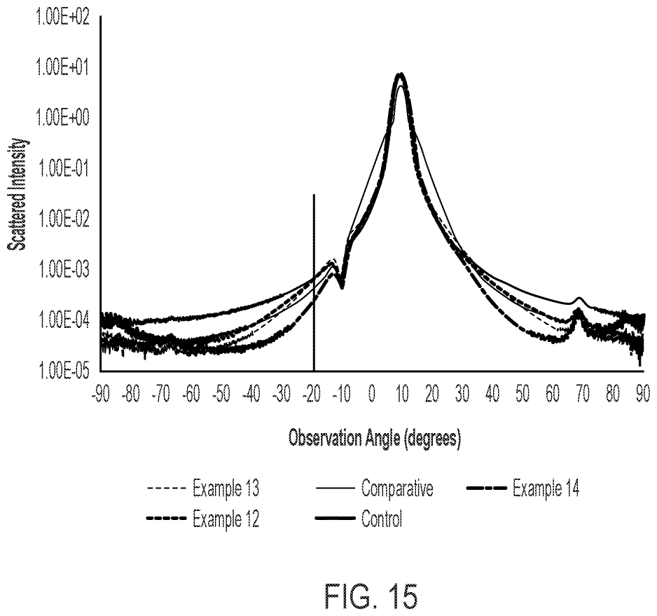

Examples 15-17 differed from the preceding examples in that the primary etching step included multiple sub-etching steps to create surface height profiles with more than 2 modes. FIG. 16A depicts a surface height profile 1600 of a control sample without any secondary etching. As shown in the histogram 1602, the surface height profile includes a first peak 1604 associated with regions of the first major surface 18 that were not etched during the primary etching step and a second peak 1606 associated with regions of the first major surface 18 that were etched during both sub-etching steps of the primary etching step. Intermediate peaks 1607 and 1608 are associated with regions of the first major surface 18 that were only etched during one of the sub-etching steps of the primary etching step. To fabricate Examples 15-17, samples with the surface height profile represented FIG. 16A were subjected to a dip etching step in a 1M HF/1M HCl solution to affect rounding of the features. FIG. 16B is surface height profile 1610 for Example 15, which was exposed to 0.5 minutes of secondary etching. FIG. 16C is surface height profile 1620 for Example 16, which was exposed to 3 minutes of secondary etching. FIG. 16D is surface height profile 1630 for Example 17, which was exposed to 5 minutes of secondary etching. As is shown in the histograms 1612, 1622, and 1632, longer time periods of secondary etching generally results in a widening of the histogram peaks. Indeed, the histograms 1622 and 1632 associated with Examples 16 and 17 only exhibited three distinct peaks, as the feature rounding caused the intermediate peaks to merge. As shown in FIG. 16D, for example, the histogram 1632 includes a first peak 1634 associated with regions of the first major surface 18 that were not etched during the primary etching step and a second peak 1636 associated with regions of the first major surface 18 that were etched during both sub-etching steps of the primary etching step. However, in contrast to the histogram 1612 associated with Example 15, the histogram 1632 only includes a single distinct intermediate peak 1638.

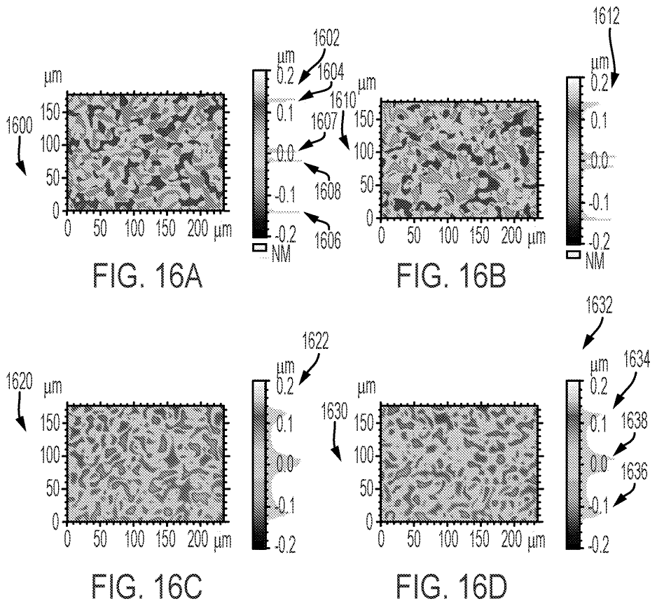

AF curves were used to further characterize Examples 15-17 and are shown in FIG. 17. As shown, longer secondary etching steps generally result in the vertical portions of the AF curve having smaller slopes from feature rounding. Vertical portions having slopes less than 400%/μm generally indicate relatively high degree of feature rounding and minimal planar areas of the scattering region 20. Each of the AF curves associated with Examples 14-17 can be characterized as having four distinct vertical portions, with each of the vertical portions having average slopes greater than 350%/μm. The vertical portions represent the peak portions 42 of the plurality of structures 26 at the different peak heights in the respective histogram. The vertical portions are separated from one another by intermediate portions that are either: (a) segments of the AF curve representing at least 50 nm in heights having an average slope that is at least 50%/μm less than the adjacent vertical portions; or (b) an inflection point of the AF curve. To illustrate, FIG. 17 includes an AF curve 1700 associated with Example 17. The features are significantly rounded in this example. The AF curve 1700 includes a first portion 1702 representing locations in the first major surface 18 where the most material was removed during the primary and secondary etching steps, a second peak portion 1704 representing locations where the least material was removed during the primary and secondary etching steps, a third portion 1706, and a fourth portion 1708. The third and fourth portions 1706 and 1708 are associated with the intermediate peak 1638 described herein with respect to FIG. 16D. The first, second, third, and fourth portions 1702, 1704, 1706, and 1708 are vertical portions of the AF curve 1700, each having an average slope greater than 350%/μm.

The AF curve 1700 further includes a first intermediate portion 1710, a second intermediate portion 1712, and a third intermediate portion 1714. The first intermediate portion 1710 separates the second portion 1704 from the third portion 1706 and comprises a segment of the AF curve 1700 representing about 0.1 μm of surface heights. The first intermediate portion 1710 comprises an average slope of about 150%/μm. The second intermediate portion 1712 is an inflection point of the AF curve 1700 separating the third portion 1706 from the fourth portion 1708. The third intermediate portion 1714 extends between the fourth portion 1708 and the first portion 1702 and comprises a segment of the AF curve 1700 representing about 0.06 μm of surface heights. The third intermediate portion 1714 comprises an average slope of about 133%/μm. As such, the AF curve comprises four vertical portions having average slopes greater than or equal to 350%/μm, with adjacent ones of the vertical portions being separated by intermediate portions that are either: (a) segments of the AF curve representing at least 50 nm in heights having an average slope that is at least 50%/μm less than the adjacent vertical portions; or (b) an inflection point of the AF curve. The AF curves associated with Examples 15 and 16 exhibited similar features, with the reduced amount of secondary etching resulting in vertical portions of greater slope and intermediate portions having smaller slopes.

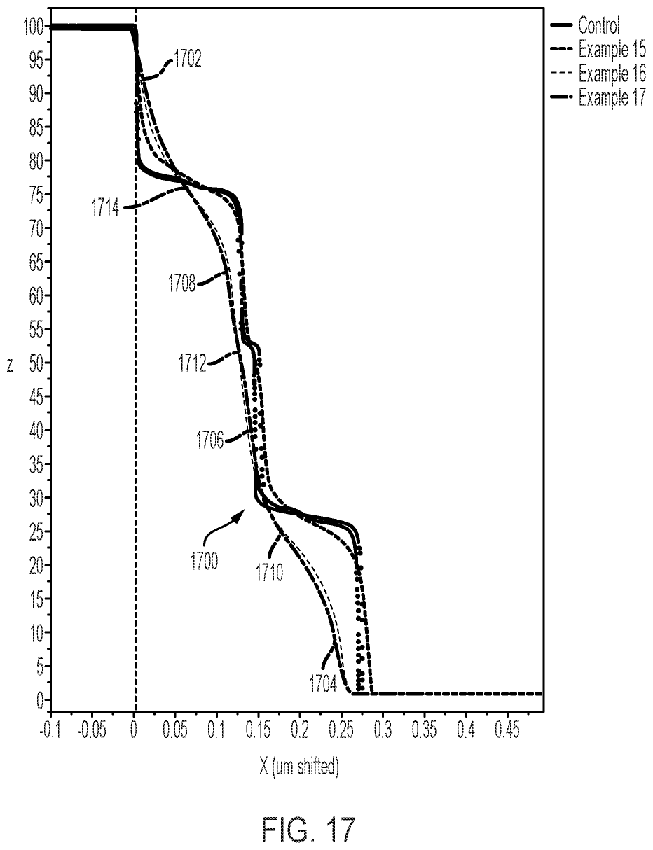

Bidirectional Reflection Distribution Function (BRDF) measurements were taken for Examples 15-17. Measurements were taken in reflection mode using the REFLET 180S system from Synopsys, Inc. The measurement wavelength range was from 400 nm to 1700 nm with light at an incident angle of 10°. FIG. 18 is a plot of the scattering amplitude in (sr⁻¹) as a function of observation angle. As shown, the samples with feature rounding exhibited lower scattering intensities at scattering angles greater than or equal to 30° relative to specular. In terms of actual (non-normalized) BRDF amplitudes, Examples 16 and 17 each exhibited BRDF amplitudes of less than 3×10⁻⁵ sr⁻¹ at a 30° scattering angle, whereas Example 15 exhibited a BRDF amplitude of 9×10⁻⁴ sr⁻¹ and the control exhibited a BRDF amplitude of 1.5×10⁻³ sr⁻¹.

It is generally believed that samples fabricated with multiple sub-etching steps in the primary etching step tend to have increased sparkle and haze relative to those fabricated using a single sub-etch step. However, specular reflection and coupled distinctness of image can be significantly reduced in the multiple sub-etching steps designs. The presence of multiple levels enables the interferometric suppression of the specular reflection over a broad optical bandwidth. Generally, the design used will be dictated by performance attributes desired for a particular application. Single sub-etch designs may be desired in applications where low haze, sparkle, and superior washout performance (such as in automotive interior displays) is desired, whereas applications demanding superior specular reflectance reduction and/or DOI may be suitable for a multi-sub-etch design.

### Examples 18-22

Examples 18-22 were fabricated in a manner similar to Examples 6-11 herein (using a single sub-etching step primary etching step followed by a secondary etching step with a varying length of time. The primary etching step for Examples 18-22 was designed so that the portions of the first major surface 18 that were not etched during the primary etching step took up about 75% of the total surface area of the scattering region 70. This was done so that the fil fraction having this height difference approximated 50% after the secondary etching step. It is believed that such a 50% fill fraction is associated with superior specular reflectance performance. The secondary etching step varied from 9 minutes to 13 minutes. The amount of the scattering region 20 that was disposed at the etch depth of the primary etching step relative to the base plane 30 after the secondary etching step was reduced in proportion to the length of the secondary etching step. Longer secondary etching steps resulted in a greater percentage reduction in fill fraction associated with portions of the scattering region that were disposed at the etch depth of the primary etching step relative to the base plane 30 after the secondary etching step. Optical properties of the examples, as well as a comparative example generated using a random, non-mask based HF etching process were measured. The results are shown in the Table 2 below.

TABLE 2

| | | | pre-etching | | | | | Change with | | | |
|---|---|---|---|---|---|---|---|---|---|---|---|
| | Primary | Secondary | Etch | | | Post etching | | etching | | | |
| | etch time | Etch Time | depth | | Slope | Etch | Fill | Etch | ΔFF | | |
| E | (s) | (s) | (μm) | FF | % | depth | fraction | depth | (%) | Trans | Haze |
| 18 | 205 | 720 | 0.195 | 74.2 | 2.5 | 0.1850 | 56.3 | −0.0100 | −17.9 | 93.2 | 2.8 |
| 19 | 197 | 780 | 0.18 | 75.3 | 2.5 | 0.1810 | 56.5 | 0.0000 | −18.8 | 93.2 | 2.66 |
| 20 | 180 | 720 | 0.18 | 76.4 | 2.3 | 0.18 | 58.1 | 0.0000 | −18.3 | 93.2 | 2.66 |
| 21 | 185 | 540 | 0.173 | 72.5 | 2.2 | 0.163 | 56.1 | −0.0100 | −16.4 | 93.2 | 2.69 |
| 22 | 185 | 660 | 0.175 | 72.8 | 2.3 | 0.166 | 56.1 | −0.0090 | −16.7 | 93.2 | 2.6 |
| CE | — | — | — | — | — | — | — | — | — | 93.2 | 5.9 |

| | | two surface measurements | | | | first surface measurements | | | | |
|---|---|---|---|---|---|---|---|---|---|---|
| | | (noncoupled) | | | | (coupled) | | | | |
| | | Gloss | Gloss | | | Gloss | Gloss | | | |
| | | 20 | 60 | | | 20 | 60 | | | |
| E | PPD | (GU) | (GU) | DOI | Rspec | (GU) | (GU) | DOI | Rs | Washout 1 |
| 18 | 1.54 | 70.75 | 109.21 | 96.49 | 55.59 | 14.99 | 58.14 | 63.92 | 5.17 | 0.713 |
| 19 | 1.46 | 72.52 | 111.93 | 96.6 | 57.44 | 15.29 | 59.2 | 60.89 | 5.24 | 0.719 |
| 20 | 1.65 | 75.25 | 113.17 | 96.77 | 60.27 | 15.74 | 59.55 | 65.3 | 5.71 | 0.729 |
| 21 | 1.53 | 75.62 | 114.15 | 96.81 | 60.58 | 16.16 | 60.46 | 67.99 | 6.17 | 0.716 |
| 22 | 1.42 | 75.18 | 113.31 | 96.65 | 59.79 | 15.91 | 60.05 | 67.9 | 5.97 | 0.727 |
| CE | 1.4 | 81.72 | 111.21 | 98.23 | 73.06 | 18.91 | 59.63 | 95.07 | 15.43 | 0.62 |

As shown, relative to the comparative examples, Examples 18-22 each exhibit significantly lower specular reflectance (each exhibited an Rs value less than 6.2), DOI (each exhibited a coupled DOI of less than 70%), and transmittance haze (each exhibited a transmittance haze of less than 3%) than the comparative example. Moreover, each exhibited a value for the washout₁ metric described herein (for light incident on the scattering region at a 20° angle of incidence and a 0° viewing angle) of greater than 0.7, which is a marked improvement over the comparative example. These results demonstrate the ability of the scattering regions described herein to achieve superior washout performance with minimal to no negative impact on other optical properties include haze, DOI, R-spec, PPD, and color breakup.

### Example 23

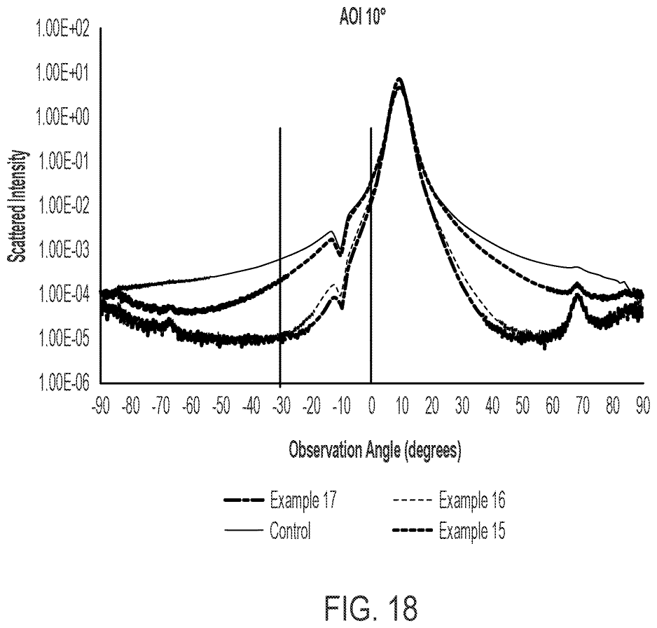

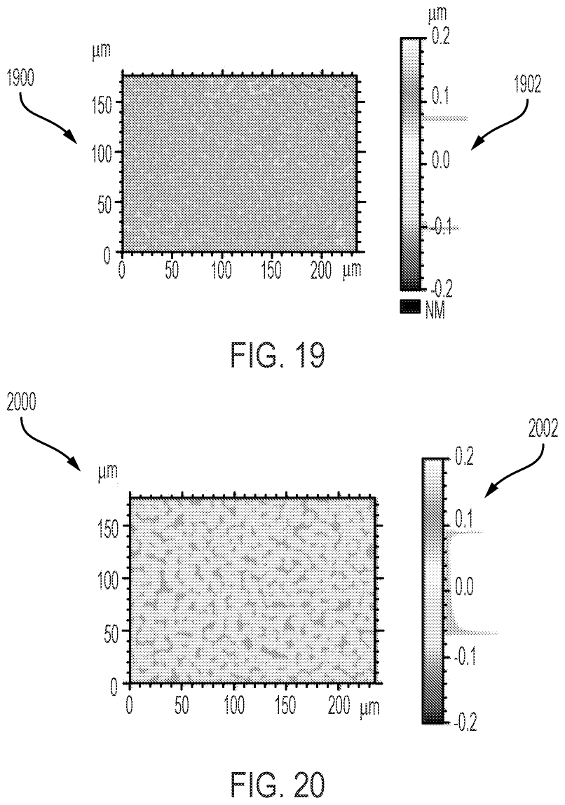

Two samples were subjected to CS8 abrasion testing to determine whether the feature rounding provided by the methods described herein provided any performance benefits from an abrasion-resistance perspective. FIG. 19 is a surface height profile 1900 and histogram 1902 associated with a baseline surface design without secondary etching. As shown, the etch depth associated with the primary etching step was about 172 nm and the surface was designed to have a 50% fill fraction associated with unetched portions of the first major surface 18. FIG. 20 shows a surface height profile 2000 and histogram 2002 associated with Example 23, which is a modified design based on the design shown in FIG. 19, after undergoing secondary etching (1M HF/1 M HCl for 2400 seconds (dip etch)). As shown in the histogram 2002, the secondary etching resulted in feature rounding, indicated by the widening of the peaks and increased counts at heights between the peaks. This feature rounding is also associated with the sloped portions 40 of the plurality of structures 26 having greater slopes, such that the transition width is greater than in the control represented in FIG. 19.

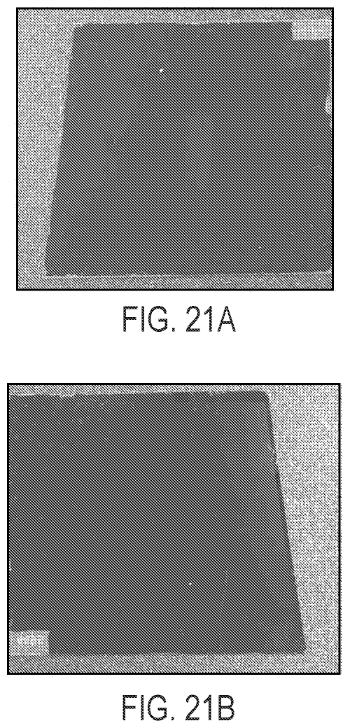

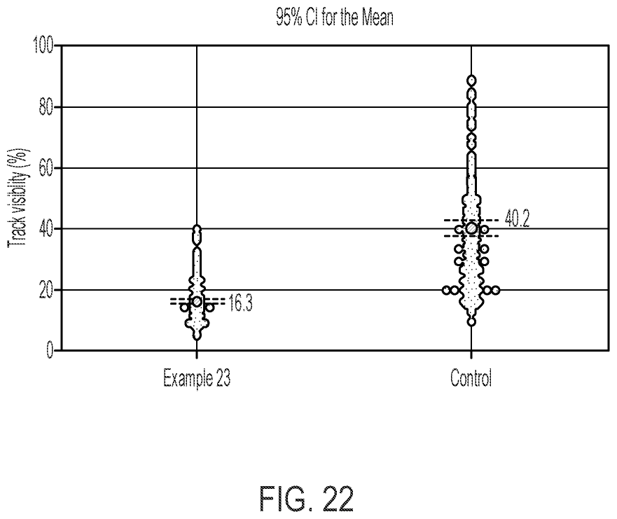

Samples represented in FIGS. 19-20 were subjected to CS8 abrasion testing. In this test, at 270 g vertical load was applied to commercially available CS8 material (comprising a rubber matrix with particles embedded therein). The CS8 material was moved with a 25 mm stroke length at a rate of 60 cycles per minute. The scattering region underwent 100 cycles of pad movement. The results are shown in FIGS. 21A and 21B. FIG. 21A shows the results for a control sample without secondary etching. FIG. 21B shows the results for Example 23. As shown, the feature rounding provided by the secondary etching resulted in significantly reduced visibility of the wear track caused by the particles. This visibility was quantified using a dark field light scattering imaging system. The system included a ring light source (24 cm diameter) emitting white light having an intensity of about 10,000 lux onto the scattering region. A digital camera (placed a linear distance of 25 cm from the sample) imaged the illuminated sample through the ring light source. The damaged area from abrasion had different light reflecting characteristics versus the unabraded section. The track visibility is defined by quantifying the contrast between the abraded region and unabraded region. To do that, the images were digitized, and the intensity of each pixel was represented using a grey scale with 0 being black and 255 being white. A threshold value was established for the unabraded section and each pixel with a grey scale value above the threshold was classified as being associated with the abraded section. For each pixel classified as being associated with the abraded section, a track visibility value was calculated as follows:

$$Track visibility = \frac{{I}_{abraded} - {I}_{non - abraded}}{{I}_{abraded} + {I}_{non - abraded}} \times 100 \% \qquad ( 10 )$$

where I_{abraded} is the measured pixel intensity associated with a pixel classified as being associated with an abraded section, and I_{non-abraded} is the measured pixel intensity associated with a nearest pixel classified as non-abraded. FIG. 22 shows histograms of track visibility values for the pixels classified as being associated with the abraded regions for the samples depicted in FIGS. 21A and 21B. As shown, Example 23 exhibited an average track visibility of less than 20%, with a maximum track visibility value of less than 40%. The control sample without secondary etching exhibited an average track visibility of more than 40%, with a maximum value exceeding 85%. These results confirm the visible observations from FIGS. 21A and 21B. The feature rounding provided by the secondary etching described herein leads to less visible damage from abrasive particles, which is beneficial for touch applications, where particulate debris is likely to be encountered.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, “a” is intended to comprise one or more than one component or element and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to comprise everything within the scope of the appended claims and their equivalents.

What is claimed is:

1. An article comprising:
a substrate comprising:
a first major surface;
a second major surface opposing the first major surface; and
a scattering region formed in the first major surface, wherein, within the scattering region, the first major surface comprises:
a plurality of structures extending outward from a base plane of the first major surface, each of the plurality of structures extending to a peak height from the base plane, wherein:
each of the plurality of structures comprises a sloped portion extending from the base plane and a peak portion that is disposed at the peak height of that structure,
sloped portions of the plurality structures make up more than 5% of a total surface area of the scattering region,
an Abbott-Firestone curve characterizing a 1×1 mm² portion of the scattering region comprises:
a first portion representing an area of the scattering region disposed most proximate to the base plane,
a second portion representing peak portions of the plurality of structures, and
an intermediate portion extending between the first portion and the second portion, and
the intermediate portion comprises an average slope that is less than 420%/μm and greater than 5%/μm in magnitude.

2. The article according to claim 1, wherein the sloped portions make up more than 50% of the total surface area of the scattering region.

3. The article according to claim 1, wherein:
at least some of the plurality of peak portions are etch depth portions disposed within 20 nm of a maximum peak height relative to the base plane, and
the etch depth portions make up less than 60% of the total surface area of the scattering region.

4. The article according to claim 3, wherein the etch depth portions make up less than 40% of the total surface area of the scattering region.

5. The article according to claim 1, wherein the plurality structures comprise a maximum feature size that is greater than or equal to 1 μm and less than 200 μm.

6. The article according to claim 1, wherein at least some of the sloped portions extend a lateral distance that is greater than or equal to 1.0 μm and less than or equal to 10 μm between the base plane and the peak portion, wherein the lateral distance extended by a sloped portion is measured in a direction parallel to a surface normal of the sloped portion and parallel to the base plane.

7. (canceled)

8. The article according to claim 6, wherein:
each of the sloped portions comprises a first edge disposed proximate the base plane and a second edge disposed proximate to the peak region, and
a slope of the first major surface changes along the direction over a 1 μm lateral distance at both the first edge and the second edge.

9. The article according to claim 1, wherein the first and second portions of the Abbott-Firestone curve are vertical portions having slopes greater than 350%/μm in magnitude.

10. The article according to claim 9, wherein:
some of the peak portions are disposed within 20 nm of a maximum peak height relative to the base plane and those peak portions are represented in the second portion of the Abbott-Firestone curve, and
the Abbott-Firestone curve comprises a third vertical portion representing peak portions that are disposed at peak heights between the base plane and the maximum peak height.

11. The article according to claim 10, wherein the Abbott-Firestone curve further comprises:
a fourth vertical portion representing additional peak portions disposed at peak heights between the base plane and the maximum peak height other than the heights associated with the third vertical portion, wherein the intermediate portion is a first intermediate portion that is disposed between the first portion and the third vertical portion;
a second intermediate portion disposed between the third vertical portion and the fourth vertical portion; and
a third intermediate portion disposed between the fourth vertical portion and the second portion.

12. The article according to claim 11, wherein each of the first intermediate portion, the second intermediate portion, and the third intermediate portion is either: (a) a segment of the Abbott-Firestone curve representing at least 50 nm in heights having an average slope that is at least 50%/μm less than adjacent vertical portions; or (b) an inflection point of the Abbott-Firestone curve.

13. The article according to claim 1, wherein the article exhibits:
a transmission haze of less than or equal to 3.5%, and
a sparkle of less than or equal to 2.5% when measured at 140 ppi.

14. The article according to claim 1, wherein a bidirectional reflectance distribution function (“BRDF”) of the article that is measured from white light that is incident on the first major surface at an angle of incidence of 10° exhibits an intensity that is less than 1.2×10⁻⁴ sr⁻¹ at a scattering angle of 30° relative to specular.

15. The article according to claim 1, wherein a first average modulation transfer function of the article that is averaged at spatial frequencies of 1.67 cycles/mm, 4.11 cycles/mm, 7.33 cycles/mm, 10.38 cycles/mm, and 13.08 cycles/mm is at least 0.7 when the article is viewed at a 0° viewing angle and light having a luminance of 45000 lux is incident on the first major surface at an angle of incidence of 20°.

16. The article according to claim 1, wherein, after 100 cycles of a pad applying a 270 g force to CS8 material against the scattering region along a track, the scattering region exhibits a track visibility that is less than or equal to 40%.

17. An article comprising:
a substrate comprising:
a first major surface;
a second major surface opposing the first major surface; and
a scattering region formed in the first major surface, wherein, within the scattering region, the first major surface comprises:
a plurality of structures extending outward from a base plane of the first major surface, each of the plurality of structures extending to a peak height from the base plane, wherein:
each of the plurality of structures comprises a sloped portion extending from the base plane and a peak portion that is disposed at the peak height of that structure, such that the scattering region comprises a plurality of sloped portions and a plurality of peak portions,
at least some of the sloped portions extend a lateral distance that is greater than or equal to 1.0 μm and less than or equal to 10 μm between the base plane and the peak portion,
the lateral distance extended by a sloped portion is measured in a direction parallel to a surface normal of the sloped portion and parallel to the base plane,
sloped portions of the plurality structures make up more than 5% of a total surface area of the scattering region, and
an Abbott-Firestone curve characterizing a 1×1 mm² portion of the scattering region does not include any horizontal portions representing at least 0.05 μm in heights having a slope less than 40%/μm in magnitude between heights representing the base plane and a peak height of the scattering region.

18. The article according to claim 17, wherein the sloped portions make up more than 5% of the total surface area of the scattering region.

19. The article according to claim 17, wherein:
at least some of the plurality of peak portions are etch depth portions disposed within 20 nm of a maximum peak height relative to the base plane, and
the etch depth portions make up less than 60% of the total surface area of the scattering region.

20. (canceled)

21. (canceled)

22. (canceled)

23. The article according to claim 17, wherein:
the Abbot-Firestone curve comprises:
a first portion representing an area of the scattering region disposed most proximate to the base plane,
a second portion representing peak portions of the plurality of structures, and
an intermediate portion extending between the first portion and the second portion,
the intermediate portion comprises an average slope that is less than 420%/μm and greater than 5%/μm,
the first and second portions of the Abbott-Firestone curve are vertical portions having slopes greater than 350%/μm in magnitude, and
some of the peak portions are disposed within 20 nm of a maximum peak height and those peak portions are represented in the second portion of the Abbott-Firestone curve.

24. The article according to claim 23, wherein the Abbott-Firestone curve comprises a third vertical portion representing peak portions that are disposed at heights between the base plane and the maximum peak height, wherein the Abbott-Firestone curve further comprises:
a fourth vertical portion representing additional peak portions disposed at peak heights between the base plane and the maximum peak height other than the heights associated with the third vertical portion, wherein the intermediate portion is a first intermediate portion that is disposed between the first portion and the third vertical portion;
a second intermediate portion disposed between the third vertical portion and the fourth vertical portion; and
a third intermediate portion disposed between the fourth vertical portion and the second portion.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
